(19) United States
(12) Patent Application Publication
(10) Pub. No.: US 2011/0055327 A1
(43) Pub. Date: Mar. 3, 2011

(54) System and Method for Service Management

(75) Inventors: Richard J. Schoech, Arlington, TX (US); Gergely V. Zaruba, Fort Worth, TX (US); Manfred Huber, Fort Worth, TX (US); David Levine, Fort Worth, TX (US); Farhad A. Kamangar, Arlington, TX (US)

(73) Assignee: Board of Regents, The University of Texas System, Austin, TX (US)

(21) Appl. No.: 12/553,339

(22) Filed: Sep. 3, 2009

(51) Int. Cl. G06F 15/16; G06T 11/20

(52) U.S. Cl. 709/204; 345/440

(57) ABSTRACT

In one aspect, a method for managing a health care plan is disclosed. The method may include accepting input characterizing a service management objective; accepting input representing a message for a client; and affecting the client's behavior with respect to the service management objective by presenting by electronic communication the message to the client according to a schedule.

### TECHNICAL FIELD OF THE PRESENT DISCLOSURE

This present disclosure relates generally to management of services including health care, social services, training, and education. More particularly, this disclosure relates to electronic communications between providers of the services delivered in accordance with service plans and the providers' clients, where the electronic communications are a means for management of the service plans, and to information displays and predictions regarding client behavior with reference to such service plans.

### BACKGROUND OF THE PRESENT DISCLOSURE

Provision of health care (“health care” herein including physical health care and mental, psychiatric, or psychological health care), social services, training, and education by provider individuals such as doctors, case managers, or teachers, and provider entities such as clinics, hospitals, social service agencies, and schools (referred to herein as “service providers”) often include service plans containing schedules for the administration of medication, appointments for examinations, therapeutic sessions, training sessions, lessons, and other events requiring a client who is receiving services from service providers to take an action or perform a task at a specific time. A service plan may often be revised or improved if a client, or people or entities associated with the client such as family members, assisted living facilities, nursing homes, foster homes, transition facilities, training facilities, and schools (referred to herein as “client associates”), may provide feedback to service providers. Such feedback may take the form of answers to survey questions or other requests for information from service providers.

As an example, a service provider such as a probation department may be required to supervise required probationary activities of a number of probationers with a variety of health, social services, training, and educational needs. For each probationer, the probation department may be required to supervise in accordance with a plan the administration of medication, appointments for examinations, counseling sessions, training sessions, or classes for the benefit of the probationer, the client in this example, with the assistance of the probationer's family or an entity such as a support facility, the client associates in this example. The client and client associates may provide feedback to the probation department.

It is helpful if a service provider may conveniently and reliably provide information and reminders to a client or a client associate concerning the services being provided and scheduled actions or events pertaining to such services, according to a service plan. It is also helpful if a client or client associate may provide information pertaining to the services being provided to a service provider. The results of a service plan may be assessed if, for instance, information from a client or client associate may be charted or otherwise displayed such that assessments of the client's conformance to the service program. Further, the results of a service plan may be improved if, for example, information from a client or client provider may be analyzed to yield predictions of client or client associate behavior with reference to the services being provided. The results of a service plan may be improved if the predictions are used to adjust the services provided to influence the client or client associate to behave more in accordance with the requirements of the services being provided.

Returning to the example of the probationer and probation department, it is helpful if the probation department may conveniently and reliably provide information and reminders to a probationer or the probationer's family member concerning, for instances, medications to be taken or refresher information about job interviewing according to the service plan. The results of the probationary service plan may be improved if, for instance, information from the probationer or a support facility may be displayed in graphical or tabular form for assessment of the probationer's conformance to the probation department's service plan. The results of the probation department's service plan may be improved if, for instance, information from the probationer or a member of the probationer's family may be analyzed to yield predictions of probationer or probationer family member performance, such as the administration of medication or success at job interviewing. The results may be improved if the predictions are used to change reminders provided by the probation department, for example, are delivered to the probationer or his or her family member in a more effective form (e.g., taped vocal reminders delivered by telephone instead of email messages).

### SUMMARY OF THE PRESENT DISCLOSURE

In one aspect, a system includes but is not limited to a server, including at least one processor operably coupled to at least one memory, the server operably coupleable to an electronic communications medium; wherein the at least one memory stores data representing a service management goal; wherein the at least one memory stores data representing a message for a client or service provider, the message designed to affect the client's behavior or the service provider's behavior with respect to the service management goal; and wherein the at least one memory stores data representing a schedule, the schedule including at least one time for using the at least one processor and the at least one memory to retrieve and present the message to the client via an electronic communications medium.

In one aspect, a method for managing a health care plan includes but is not limited to accepting input characterizing a service management objective; accepting input representing a message for a client; and affecting the client's behavior with respect to the service management objective by presenting by electronic communication the message to the client according to a schedule.

In one aspect, a machine-readable medium that provides instructions, which when executed by a machine, cause said machine to perform operations, includes instructions for operations including but not limited to accepting input characterizing a service management objective; accepting input representing a message for a client; and affecting the client's behavior with respect to the service management objective by presenting by electronic communication the message to the client according to a schedule.

In one or more various aspects, related articles, systems, and devices include but are not limited to circuitry, programming, electro-mechanical devices, or optical devices for affecting the herein referenced method aspects. The circuitry, programming, electro-mechanical devices, or optical devices can be virtually any combination of hardware, software, and firmware configured to affect the herein referenced method aspects.

In addition to the foregoing, various other method, device, and system aspects are set forth and described in the teachings, such as the text (e.g., claims or detailed description) or drawings, of the present disclosure.

The foregoing is a summary and thus contains, by necessity, simplifications, generalizations and omissions of detail; consequently, those skilled in the art will appreciate that the summary is illustrative only and is not intended to be in any way limiting. Other aspects, features, and advantages of the devices, processes, or other subject matter described herein will become apparent in the teachings set forth herein.

### BRIEF DESCRIPTION OF THE DRAWINGS

FIG. 1 shows an exemplary system for communications and processing for service management in accordance with some embodiments of the present disclosure;

FIG. 2 shows an exemplary high-level architecture for a software program or set of software programs and associated hardware for service management in accordance with some embodiments of the present disclosure;

FIG. 3 shows a high-level flow chart of an operational process for an exemplary operation of a service provider setup module;

FIG. 4 shows a high-level flow chart of an operational process for exemplary operations of a system provider setup module;

FIG. 5 shows a high-level flow chart of an operational process for use of a schedule/call module together with a survey/message module;

FIG. 6 shows a high-level flow chart of an operational process for use of a survey/message module together with a schedule/call module;

FIG. 7 shows a high-level flow chart of an operational process for use of a graphics module;

FIG. 8A shows a high-level flow chart of an operational process for use of a prediction module;

FIG. 8B shows a high-level flow chart of an operational process for use of a mining module;

FIG. 9 shows a screenshot of a website including a table of users of a service management system;

FIG. 10 shows a screenshot of a website for entry of data pertaining to users of a service management system;

FIG. 11 shows another screenshot of a website for entry of data pertaining to users of a service management system;

FIG. 12 shows a screenshot of a website including a table with client information;

FIG. 13 shows a screenshot of a website for entry of data pertaining to a client;

FIG. 14 shows a screenshot of a website for entry of data pertaining to a client's treatment plan;

FIG. 15 shows a screenshot of a website showing the surveys constructed for a client;

FIG. 16 shows a screenshot of a website for beginning the process of constructing a survey;

FIG. 17 shows a screenshot of a website for adding templates for a client;

FIG. 18 shows a screenshot of a website for selecting and generating reports about a client's activities based on the client's objectives, surveys, and templates;

FIG. 19 shows a screenshot of a website providing for searching of stored templates and display of stored templates;

FIG. 20 shows a screenshot of a website for construction of a template;

FIG. 21 shows a screenshot of a website for display of questions and messages that are available for inclusion in templates;

FIG. 22 shows a screenshot of a website for adding questions and messages to those available;

FIG. 23 shows a screenshot of a website for display of response types available as responses to questions and some messages;

FIG. 24 shows a screenshot of a website for adding a response type to those available;

FIG. 25 shows a screenshot of a website for displaying the audio file of medication names that are available for messages to clients;

FIG. 26 shows a screenshot of a website for adding medication name audio files to those available;

FIG. 27 shows a screenshot of a website for display of alerts available for use with clients;

FIG. 28 shows a screenshot of a website for adding new alerts;

FIG. 29 shows a screenshot of a website for display of medications available for use in questions and messages for clients;

FIG. 30 shows a screenshot of a website for adding medications to those available;

FIG. 31 shows a screenshot of a website for display of diagnoses available for use in characterizing clients;

FIG. 32 shows a screenshot of a website for adding diagnoses to those available;

FIG. 33 shows a screenshot of a website for display of available problem descriptions for use in characterizing clients;

FIG. 34 shows a screenshot of a website for adding problem descriptions to those available;

FIG. 35 shows a screenshot of a website for display of available programs for use with clients;

FIG. 36 shows a screenshot of a website for adding programs to those available;

FIG. 37 shows a screenshot of a website for display of goals for use with clients;

FIG. 38 shows a screenshot of a website for adding goals to those available;

FIG. 39 shows a screenshot of a website for display of objectives for use with clients;

FIG. 40 shows a screenshot of a website for adding objectives to those available;

FIG. 41 shows a screenshot of a website for display of the types of users;

FIG. 42 shows a screenshot of a website for setting up templates including survey configurations; and

FIG. 43 shows a screenshot of a website displaying a template for a client.

While the present disclosure is subject to various modifications and alternative forms, specific embodiments thereof are shown by way of example in the drawings and the accompanying detailed description. It should be understood, however, that the drawings and detailed description are not intended to limit the present disclosure to particular embodiments. This disclosure is instead intended to cover all modifications, equivalents, and alternatives falling within the scope of the present disclosure as defined by the appended claims.

### Notation and Nomenclature

Certain terms are used throughout the following description and claims to refer to particular system components and configurations. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the terms “couple,” “couples,” “coupleable,” or “coupling” are intended to mean either an indirect or direct electrical or wireless connection. Thus, if a first device couples to a second device, that connection may be through a direct electrical or wireless connection, or through an indirect electrical or wireless connection by means of other devices and connections.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

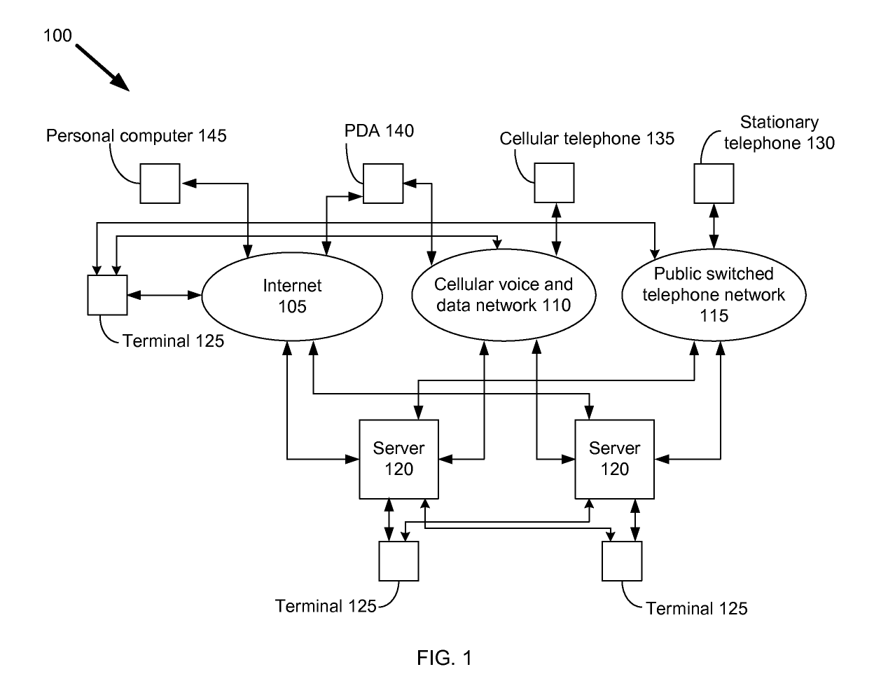

Turning now to FIG. 1, an exemplary system 100 for communications and processing for service management is shown. Various elements of the system may be operably coupled via the Internet 105, a cellular voice and data network 110, a public switched telephone network 115, or some combination of two or more of these media. The exemplary system 100 may include servers 120 that may be operably coupled to one or more of the Internet 105, the cellular voice and data network 110, and the public switched telephone network 115. Terminals 125 may be operably coupled to the servers 120 or to one or more of the Internet 105, the cellular voice and data network 110, and the public switched telephone network 115. A terminal 125 may be a computer such as a personal computer, a laptop computer, a purpose-built terminal unit, or some other computer interface unit. Various devices for receiving and sending data, such as a stationary telephone 130, a cellular telephone 135, a personal data assistant (herein, “PDAs”) 140, or a personal computer 145, may be operably coupled to one or more of the Internet 105, the cellular voice and data network 110, and the public switched telephone network 115.

The servers 120 may be used to run software for service management or to provide for data transfer between the terminals 125 and the Internet 105, the cellular voice and data network 110, and the public switched telephone network 115. The terminals 125 may be used to run software for service management or for input and output of data relevant to service management. Devices such as the exemplary stationary telephones 130, cellular telephones 135, PDAs 140, and personal computers 145, may also be used to run software for service management or for input and output of data relevant to service management.

Referring to the example of the “Background of the Present Disclosure” section of this specification, the probation department may use the servers 120 to run software for management of the services it provides for probationers and to provide for the transfer of data required by a probationer's service plan between the terminals 125 used by the probation department and the Internet 105, the cellular voice and data network 110, and the public switched telephone network 115. The probationer or an associate of the probationer such as a family member or a support facility may use a stationary telephone 125, a cellular telephone 135, a PDA 140, or a personal computer 145 to run software for service management or for input and output of data relevant to service management.

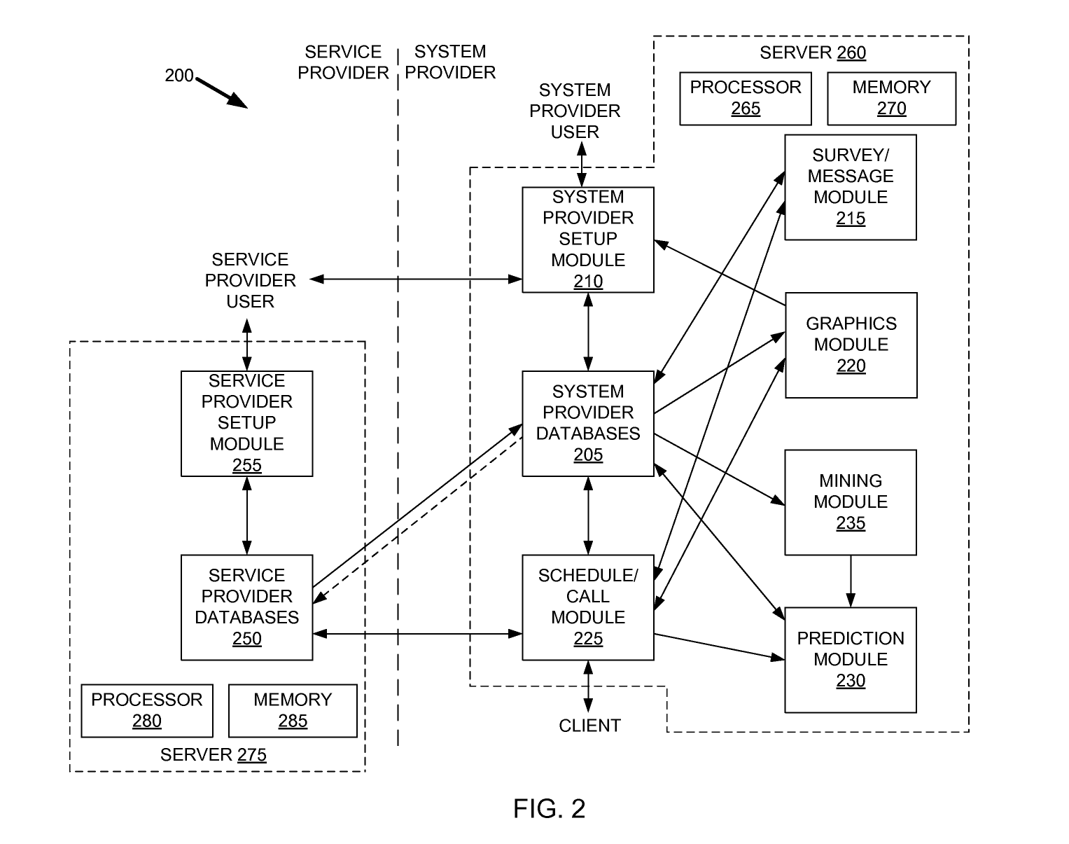

Turning now to FIG. 2, an exemplary high-level architecture 200 for a software program or set of software programs and associated hardware for service management in accordance with some embodiments of the present disclosure is shown. In the exemplary service management architecture 200, an entity that provides the system for service management, the system provider, provides and operates one or more system provider databases 205, a system provider setup module 210, a survey/message module 215, a graphics module 220, a schedule/call module 225, a prediction module 230, and a mining module 235. The system provider also provides to an entity that provides the service for which management is required, the service provider, one or more service provider databases 250 and a service provider setup module 255. The system provider may be a developer and/or a vendor of the software used for service management, and the service provider may be a government or private organization that provides service to individual clients, such as a local probation department providing services to probationers or a local mental health service agency providing services to patients.

Each of the one or more system provider databases 205, the system provider setup module 210, the survey/message module 215, the graphics module 220, the schedule/call module 225, the prediction module 230, and the mining module 235 may be run on one or more system-provider side servers or other computer resources, represented in FIG. 2 by the one or more servers 260, with one or more processors 265 and one or more processors 270. Each of the one or more service provider databases 250 and the service provider setup module 255 may be run on one or more service-provider-side servers or other computer resources, represented in FIG. 2 by the one or more servers 275, with one or more processors 280 and one or more memories 285. The servers 260 and 275 may be, for example, the servers 120 of FIG. 1. The one or more system-provider-side servers 260 may communicate with the one or more service-provider-side servers 275 via, for example, the Internet 105, the cellular voice and data network 110, and/or the public switched telephone network 115 of FIG. 1.

Continuing with reference to FIG. 2, the one or more processors 265 and one or more memories 270 may be shared among the one or more system provider databases 205 and the system provider setup module 210, the survey/message module 215, the graphics module 220, the schedule/call module 225, the prediction module 230, and the mining module 235. Each of these databases 205 and the modules 210, 215, 220, 225, 230, and 235 may be implemented to accept input and provide output via a variety of computer-based tools such as a display screen, an Internet browser, a web page, an audio speaker, a microphone, a keypad, a keyboard, a touchpad, or a mouse, or some combination of these items.

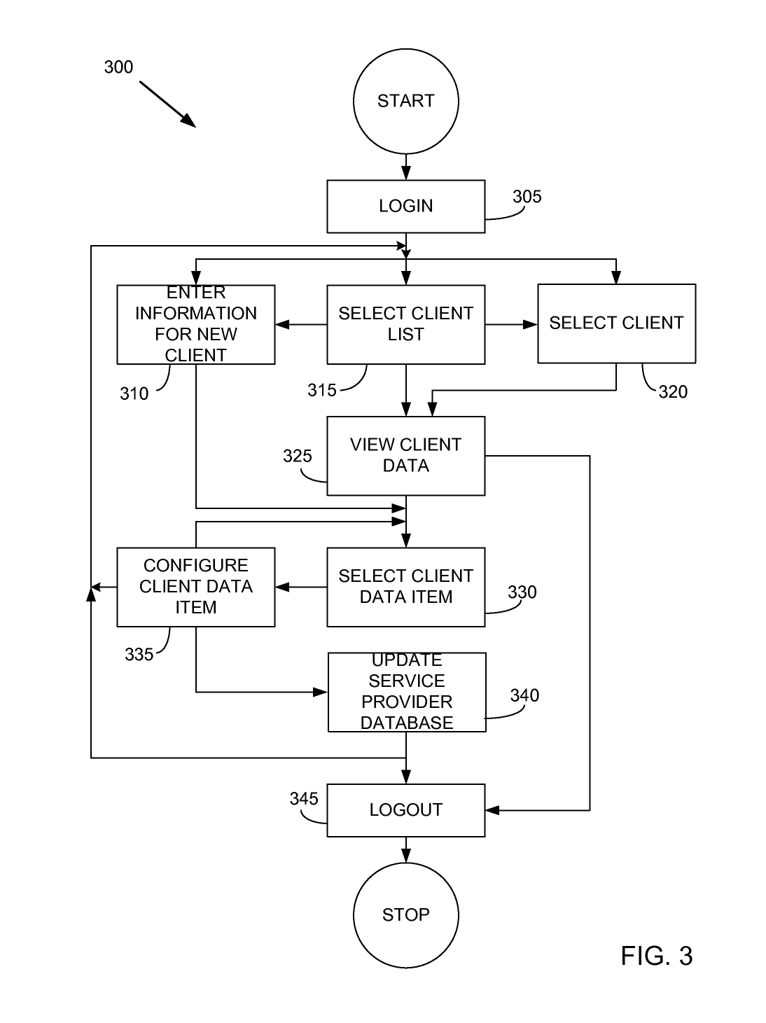

The one or more processors 280 and the one or more memories 285 may be shared among the one or more service provider databases 250 and the service provider setup module 255. Like the databases and the modules on the system provider side, each of these service provider databases 250 and the service provider setup module 255 may be implemented to accept input and provide output via a variety of computer-based tools such as a display screen, an Internet browser, a web page, an audio speaker, a microphone, a keypad, a keyboard, a touchpad, or a mouse, or some combination of these items. The service provider setup module 255 may be used by a service provider user such as a case worker in a probation department to enter or change data concerning a client such as a probationer, including, for instance, the client's name, an identification number, one or more telephone numbers, and one or more email addresses. These data may be stored in the one or more service provider databases 250. In an aspect of present disclosure, the service provider setup module 255 may be operably coupled only to the one or more service provider databases 250. An exemplary operation of the service provider setup module 255 is described herein in connection with FIG. 3.

Turning to the system provider side, broadly speaking, aspects of the present disclosure may be used to provide service management for clients with a variety of problems, including, for example, bipolar disorder, major depressive disorder, schizophrenia or schizoaffective disorder, or substance use disorder. A specific program may be made available for service management for a client with an identified problem. In addition, a service provider may specify one or more broadly-stated goals, such as “Improve the quality of life of the client,” “Stabilize client's family relationships,” or “Stabilize the client's psychiatric condition.” These goals may be made practically attainable by the specification of one or more objectives, which may include, for example, “Reduce substance abuse,” “Adhere to medication regimen,” “Keep scheduled appointments,” or “Report any negative side effects of medication(s).” The system provider setup module 210 may be used by either a service provider user such as a case worker or a system provider user such as a system specialist to enter, change, or select for an use with a client a variety of data used by aspects of the present disclosure, including the problems, programs, goals, and objectives. These data may also include (1) one or more questions that call for responses from a client and (2) one or more messages that convey to the client instructions, information, and/or motivational statements. Questions may include, for example, “ ”This is your daily checkup? Is everything going OK?” or “Do you think you will miss your next appointments?” Messages may include, for instance, “Great, keep up the good work” or “Remember using illegal drugs while taking Seroquel can be harmful to health.” These data may also include one or more templates comprising a set of questions and/or messages, the questions and/or messages being associated with a specific objective for the client. In addition, these data may include one or more surveys, each comprising one or more templates, to be presented to clients to assist management of service plans.

A template included by a survey directed to a client may include, for instance, the identified problem, “substance abuse”; a specific program to address the problem, the identified goal, “therapy for family”; and the specified objective, “to improve the client's ability to handle anger that increases the risk of substance abuse.” A survey may generally include a request for authentication such as a PIN, a welcome message, a request to answer one or more questions, the one or more questions, and a closing message. For example, an exemplary survey that includes the foregoing exemplary template may include:
(1) the welcome message, “This is your daily checkup”;
(2) the question, “Have you had an angry outburst today?”;
(3) if “yes” to (2), the question, “How many anger outbursts did you have today?”;
(4) the question, “Are you aware of what triggered your angry outbursts?”;
(5) if “yes” to question (4), the motivational statement, “Great, understanding what triggers an outburst is one of the first steps in preventing future outbursts”;
(6) if “no” to question (4), the question, “Before your anger outbursts, were you typically aware of any signs that you were getting angry?”;
(7) if “yes” to question (6), the motivational statement, “Great, being in tune with the signs that precede an anger outburst will help you control your anger”;
(8) if “no” to question (6), the motivational statement, “That is great to hear”;
(9) the parting statement, “Remember that if you experience any problems which you find too bothersome, please go to your local emergency room, call 911, or call the crisis hotline at 817-555-4444. If you would like to leave a short, non-emergency message for your case manager, leave it now.”

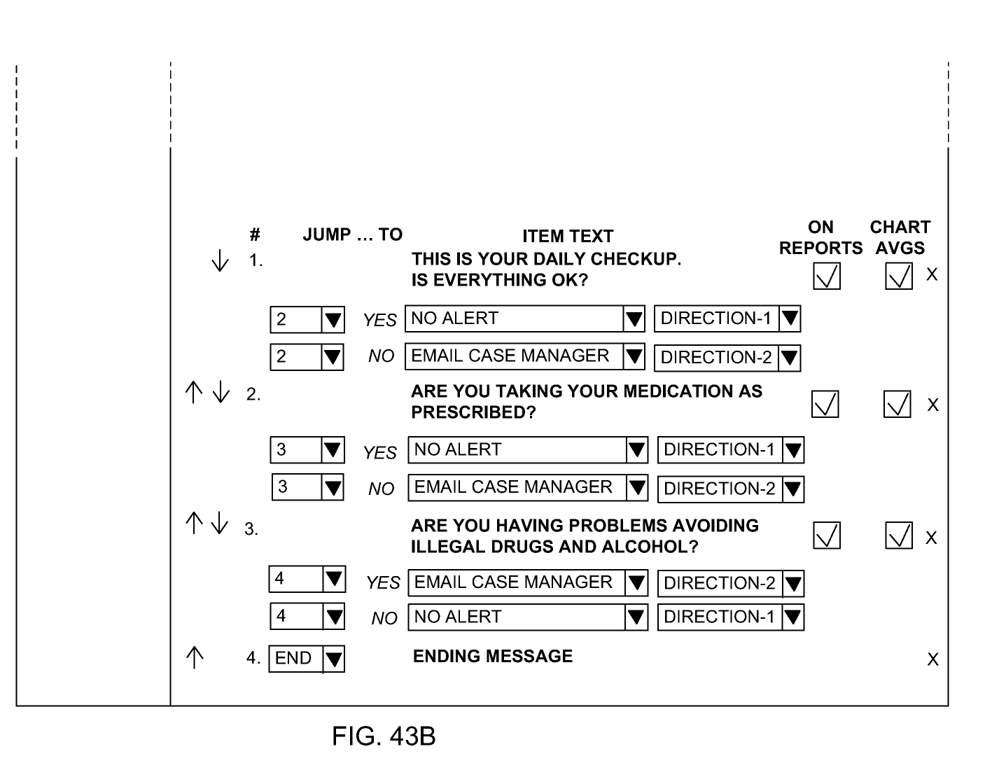

Another exemplary template directed to a client with a different set of survey questions is shown in FIG. 43. FIG. 43 shows the “Update Template” screen 4305 that allows changes to survey questions and different actions based on the response by the client to the question.

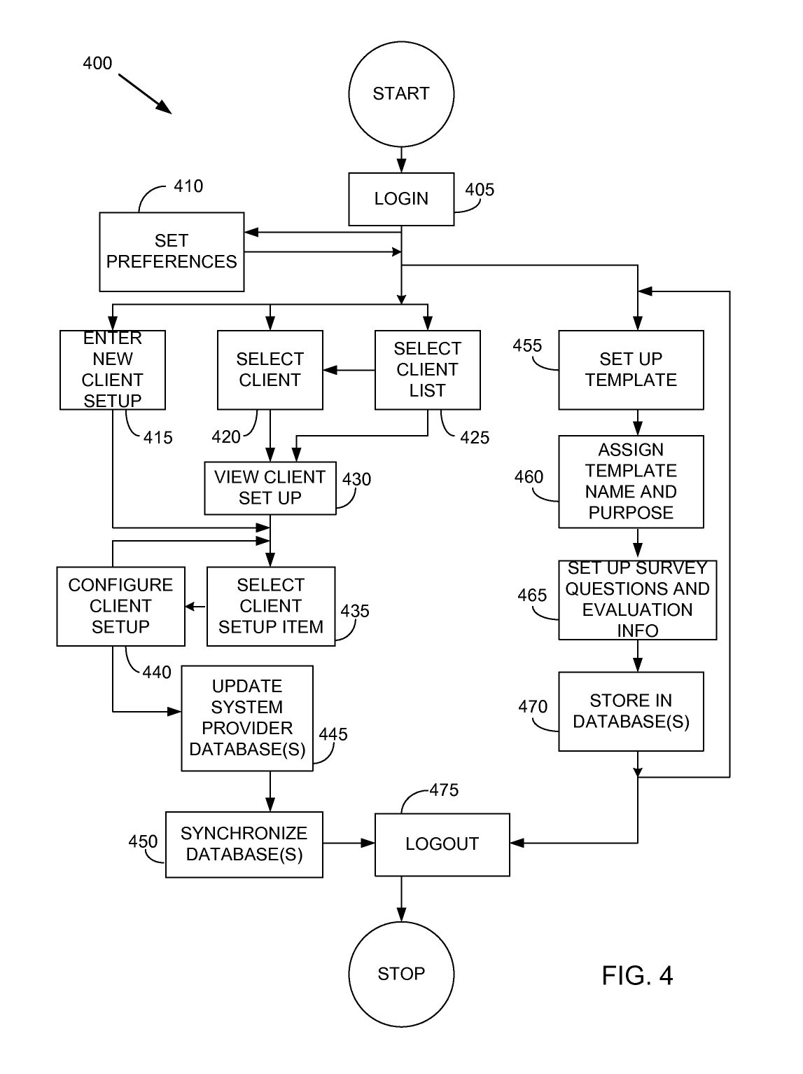

Questions and messages from which templates and surveys may be constructed, as well as the templates and surveys constructed from the questions and messages, may be entered by users via the system provider setup module 210 and may be stored in the one or more system provider databases 205. Exemplary operations of the system provider setup module 210 are described in connection with FIG. 4.

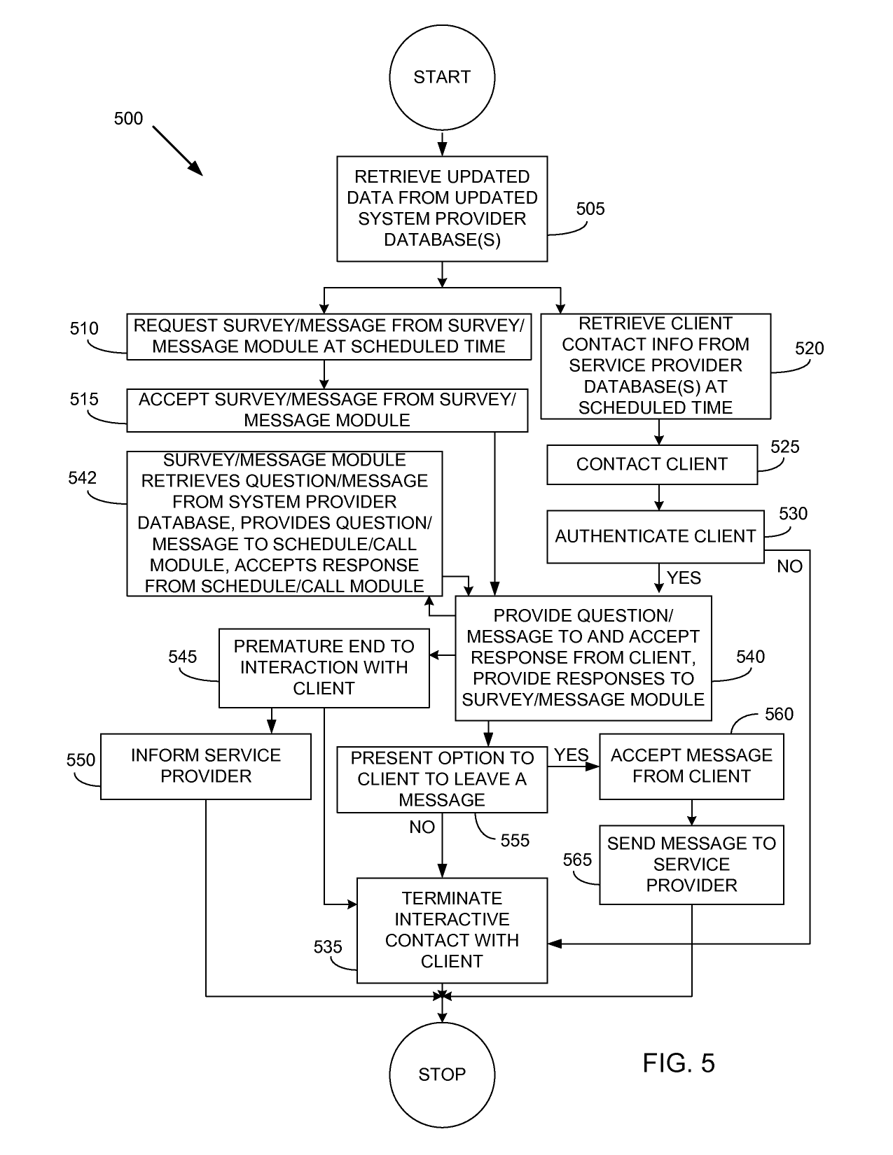

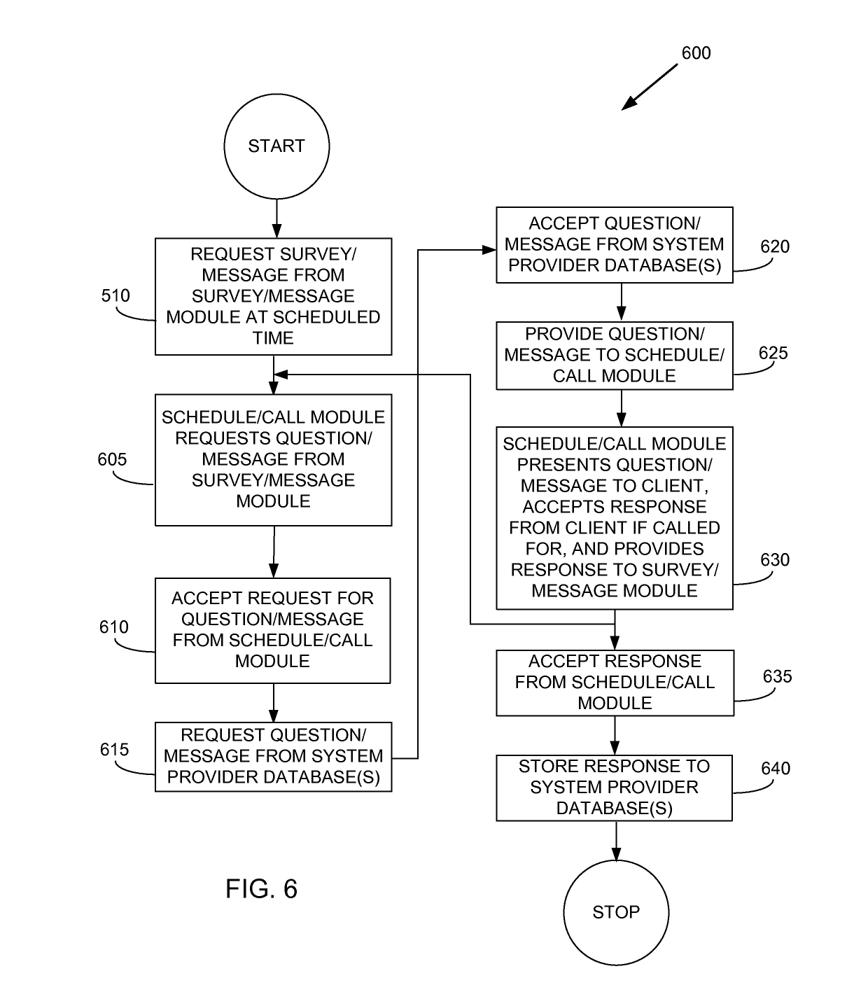

The schedule/call module 225 may be used to present a survey (including either one or more questions, one or more messages, or both) to a client and to accept responses from the client. The schedule call module may work in conjunction with the survey/message module 215 and the one or more system provider databases 205. An exemplary operation of the schedule/call module 225 used in conjunction with the survey/message module 215 and the one or more system provider databases 205 is described in connection with FIGS. 5 and 6.

Turning to FIG. 3, a high-level flow chart of an operational process 300 for an exemplary operation of the service provider setup module 255 of FIG. 2 is shown. As discussed, the service provider setup module 255 of FIG. 2 may be used by users associated with a service provider, such as case workers with a probation department or a public mental health service, to set up the basic identifying and contact information for a client of the service provider, such as a probationer or a mental health patient. A user associated with a service provider may login to the service provider setup module 255 (operation 305). After logging in, the user may choose to enter information for a new client (operation 310), select a list of existing clients (operation 315), or select a single existing client (operation 320). If a user selects a list of existing clients (operation 315), the user may elect to enter information for a new client to be associated with that list (operation 310) or select a single existing client from the client list (operation 320). If a user selects a client list (operation 315) or a client (operation 320), the user may view client data (operation 325). Having viewed client data, the user may select a client data item such as a name, a phone number, or a scheduled appointment (operation 330). If the user elected to enter information for a new client (operation 310), the user may select a client data item to add for the new client (operation 330). Once the user selects a client data item (operation 330), the user may choose to configure the client data item (operation 335), which may include adding, changing, or deleting the client data item, or leaving the client data item as it is. Once the user configures the client data item (operation 335), he may enter information for another new client (operation 310), select a list of existing clients (operation 315), or select an existing client (operation 320). If the user is finished, the service provider database 250 updates automatically (operation 340). The user may then logout of the service provider setup module 255 (operation 345). If the user interface with the service provider setup module 255 is implemented to be used with a web browser, the user may skip from one operation to another among those illustrated in FIG. 3 without necessarily following the flow chart as illustrated.

Turning now to FIG. 4, a high-level flow chart of an operational process 400 for exemplary operations of the system provider setup module 210 is shown. The system provider setup module 210 of FIG. 2 may be used by users associated with the service provider, such as case workers with a probation department or a public mental health provider, to configure a client setup. The system provider setup module 210 of may also be used by users associated with a system provider, such as a system specialist with a system vendor, to set up templates for use by service providers. A user of either type may login (operation 405). A user may set one or more preferences for the presentation of data (operation 410). Such preferences may pertain to a set of clients or to an individual client. Taking the case of a service provider user first (or, for example, a system provider user working under the direction of a service provider user), such a user, having logged in, may enter a new client setup (operation 415), select a client list (operation 420) or a client (operation 425), from which the user may select a client (operation 420). Once a client is selected (operation 420), the service provider user may view the client setup for that client (operation 430). Once a client setup is viewed (operation 430), the user may select a client setup item (operation 435), such as a survey that has been selected to be presented to that client. Having selected a client setup item (operation 435), the user may configure the client setup item (operation 440), where configuring may include adding an item, changing an item, or deleting an item. The user may also configure a client setup item (operation 440) after deciding to enter a new client setup (operation 415). Once a client setup has been configured (operation 440), the one or more system provider databases may be updated to reflect the configuration (operation 445). Once the one or more system provider databases have been updated (operation 445), the one or more system provider databases and the one or more service provider databases may be synchronized (operation 450). That is, the client setups stored in the one or more system provider databases may be linked with the client identifiers stored in the one or more service provider databases through system-provider-side client identifiers used to protect the privacy of client information.

Continuing with the exemplary operational process 400, system provider users may login to the system provider setup module 210 of FIG. 2 (operation 405). The system provider user may set preferences for the display of data (operation 410). Once logged in (operation 405), the system provider user may select the set up of a template (operation 455). Having selected the set up of a template (operation 455), the user may assign a name and a purpose to the template he or she is setting up (operation 460). After assigning a name and a purpose to the template (operation 460), the user may set up the survey questions and evaluation information that are to be part of the template (operation 465). Once the template's survey questions and evaluation information have been set up for the template, the user may store the template in the one or more system provider databases 205 (operation 470). The user may select setting up another template (operation 455) or may log out (operation 475).

Turning now to FIG. 5, a high-level flow chart of an exemplary operational process 500 is shown. The exemplary operation process 500 may use the schedule/call module 225 of FIG. 2 to present a survey to a client such as a probationer or a mental health patient. The schedule/call module 225 may retrieve updated data from the one or more system provider databases 205 periodically or when the one or more system provider databases 205 when client identifying and/or contact information and/or one or more templates associated with a client are updated as a result of, for instance, one or more operations of the exemplary operational processes 300 or 400, of FIGS. 3 and 4, respectively. The schedule/call module 225 may request a survey and/or a message from the survey/message module 215 (operation 510), where the survey specifies either one or more templates comprising one or more questions to be presented to a client, or one or more messages to be sent to a client (such as a reminder message), or both.

Continuing with reference to FIG. 5, after the schedule/call module 225 requests one or more surveys and/or messages from the survey/message module 215 (operation 510), the survey/message module 215 may accept the requested one or more surveys and/or messages from the survey/message module 215 (operation 515). The schedule/call module 225 may also request client contact information from one or more the service provider databases 250 (operation 520). In some circumstances, such information must be protected by laws, regulations, or policies such as the Health Information Portability and Accountability Act (HIPAA), such that the schedule/call module 225 may retrieve the contact information for use in contacting the client at the time the client is to be contacted, and once the client has been contacted, the contact information may be deleted from the schedule/call module 225. Using the retrieved client contact information, the schedule/call module 225 may contact the client, for instance, by placing a telephone call or sending an email message to the client (operation 525). Once the contact has been made, the schedule/call module 225 may authenticate the client (operation 530) by, for instance, requesting a password. If the contact has been made by a telephone call, the schedule/call module may request a spoken password with a stored audio message and process the response using voice and/or word recognition software. If the contact has been made by email message, the email message may, for example, direct the client to a website where the client may be prompted to enter a password. If the client is not authenticated, the exemplary operational process 500 may be terminated (operation 535).

Continuing with reference to FIG. 5, if the client is authenticated (operation 530), the schedule/call module 225 may request from the survey/message module 215 one or more survey questions and/or messages included in the one or more templates, present to the client the one or more survey questions and/or one or more messages included in the one or more templates designed for this client and requested from the survey/message module 215, and may accept responses from the client (operation 540). In conjunction with the activities included in operation 540, the schedule/call module 225 may interact with the survey/message module 215 during interactive contact with the client. As depicted in FIG. 5, in conjunction with operation 540, the survey/message module 215 may retrieve the one or more survey questions and/or messages included in the one or more templates from the one or more system provider databases 205, may provide the one or more survey questions and/messages to the schedule/call module 225 when requested to by the schedule/call module, and may accept client responses from the schedule/call module 225 (operation 542). (Interaction between the schedule/call module 225 and the survey/message module 215 is described in more detail with reference to FIG. 6 herein.)

If the contact has been made, for instance, by telephone, the survey questions and/or messages may be presented by stored audio and the responses may be accepted by word recognition software. If the client interacts with the schedule/call module 225 via a website, the questions and/or messages may be presented via dialogue boxes or other graphical user interface features and may accept responses entered by the client to the interactive features of the website. Operation 540 may be conducted interactively as the survey and/or messages are presented to the client. For example, the client may be presented with a question by the schedule/call module 225, and the schedule/call module 225 may accept a response from the client and provide it to the survey/message module 215. The survey/message module 215 may use the response to determine the next action, for instance, a first question that depends on the receipt of a first response or a second question that depends on the receipt of a second response. The survey/message module 215 may store the client's response to the one or more system provider databases 205 and may retrieve the appropriate question from the one or more system provider databases 205, for example, the second question, as a result of receiving the second response from the client, and may make it available to the schedule/call module 225. The schedule/call module 225 may then retrieve the second question from the survey/message module 215 and may present that second question to the client. (Interaction between the schedule/call module 225 and the survey/message module 215 is described in more detail with reference to FIG. 6 herein.) If the client interaction ends prematurely (operation 545), for instance, before the survey questions have been responded to by a client hanging up the telephone or ceasing providing responses, or by a client ceasing interaction with a website, the service provider may be informed (operation 550), for example, by a stored audio message delivered by telephone or an email message, and the exemplary operational process 500 may be terminated (operation 535).

Continuing with reference to FIG. 5, after the one or more survey questions and/or one or more messages included in the one or more templates designed for this client are presented and responses accepted (operation 540), the schedule/call module 225 may present an option to the client to leave a message for the service provider (operation 555), for instance for his or her case manager. If the client elects to leave a message, the schedule/call module 225 may accept the message (operation 560), for example, by recording and storing an audio message or by accepting a typed texted message via a website. The schedule/call module 225 may then terminate contact with the client (operation 535) and send the message to the service provider (operation 565).

Turning now to FIG. 6, a high-level exemplary operational flow chart of an exemplary operational process 600 is shown. The exemplary operational process 600 details an interaction between the survey/message module 215 and the schedule/call module 225 during the operational process 500 illustrated in FIG. 5, from the perspective of the survey/message module 215. Beginning with the operation 510 of FIG. 5, the schedule/call module 225 may request a survey and/or a message from the survey/message 215 at a time scheduled for contact with a client. After the schedule call module contacts the client (operation 525 of FIG. 5) and authenticates the client (operation 530 of FIG. 5), the schedule/call module 225 may request from the survey/message module 215 a question or a message to be presented to a client (operation 605 of FIG. 6; operation 540 of FIG. 5). The survey/message module 215 may accept the request for the question or the message from the schedule/call module 225 (operation 610 of FIG. 6; operation 542 of FIG. 5). The survey/message module 215 may then request the question or the message from the one or more system provider database 205 (operation 615 of FIG. 6; operation 542 of FIG. 5). Having made the request, the survey/message module 215 may accept the question or the message from the one or more system provider database(s) 205 (operation 620 of FIG. 6; operation 542 of FIG. 5). The survey/message module 215 may provide the question or the message to the schedule/call module 225 (operation 625 of FIG. 6; operation 542 of FIG. 6). The schedule/call module 225 may present the question or the message to the client, accept a response to the question or to the message if called for, and provide the response to the survey/message module 215 (operation 630 of FIG. 6; operation 542 of FIG. 5). If the response from the client or the survey to be presented to the client calls for another question or message for the client, the operational process 600 allows for a return to operation 605 after operation 630 and a repetition of operations 605, 610, 615, 620, 625, and 630. This repetition is a detailed account of the repetition indicated between operation 540 and 542 in FIG. 5. The survey/message module 215 may accept the response accepted in operation 630 from the schedule/call module 225 (operation 635 of FIG. 6; operation 542 of FIG. 5). The survey/message module 215 may store the response to the one or more system provider database 205 (operation 640 of FIG. 6; not shown in FIG. 5). If the interaction with the client ends prematurely, the operation process 600 ends and the operational process 500 may continue from operation 545. If the operational process 600 ends after operation 640, the operational process 500 of FIG. 5 may continue from operation 555.

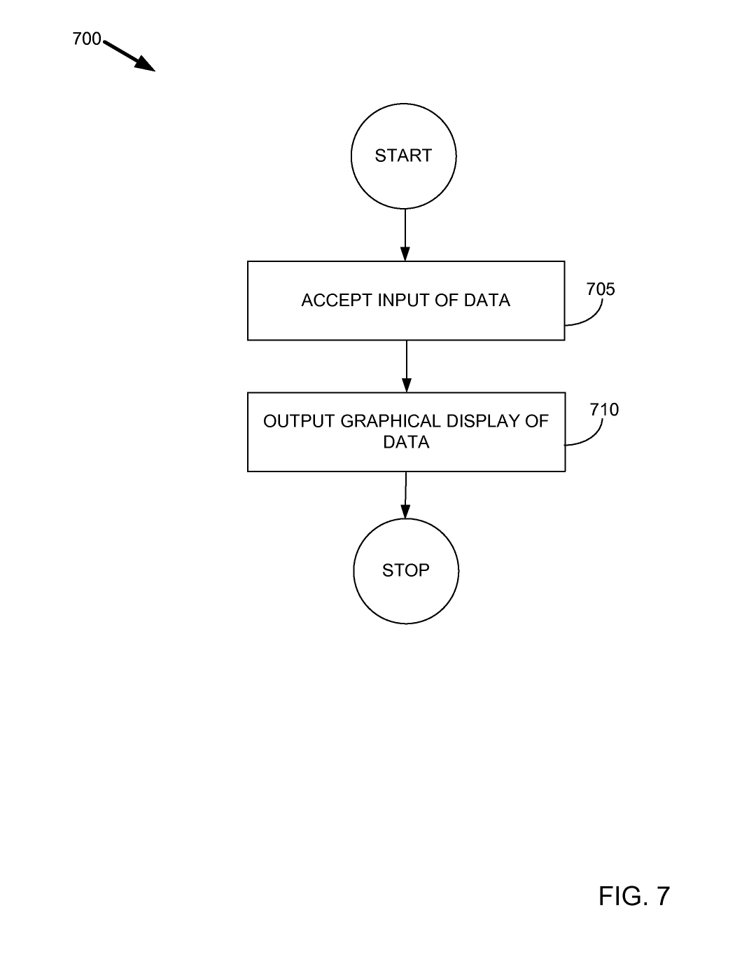

Turning now to FIG. 7, a high-level operational flow chart of an exemplary operational process 700 is shown. Operation 705 may include accepting data from one or more of the system provider databases 205 of FIG. 2. For instance, the graphics module 220 may accept input from a database 205, such as input representing a probationer's responses or a client's responses to survey questions. Operation 710 may include outputting a visual display of the information in the form of, for example, a graph or a table. For example, the responses of a probationer or a patient to a survey question over time may be outputted as a graph with a horizontal time axis and a vertical axis representing the range of answers available for the probationer or the patient to make.

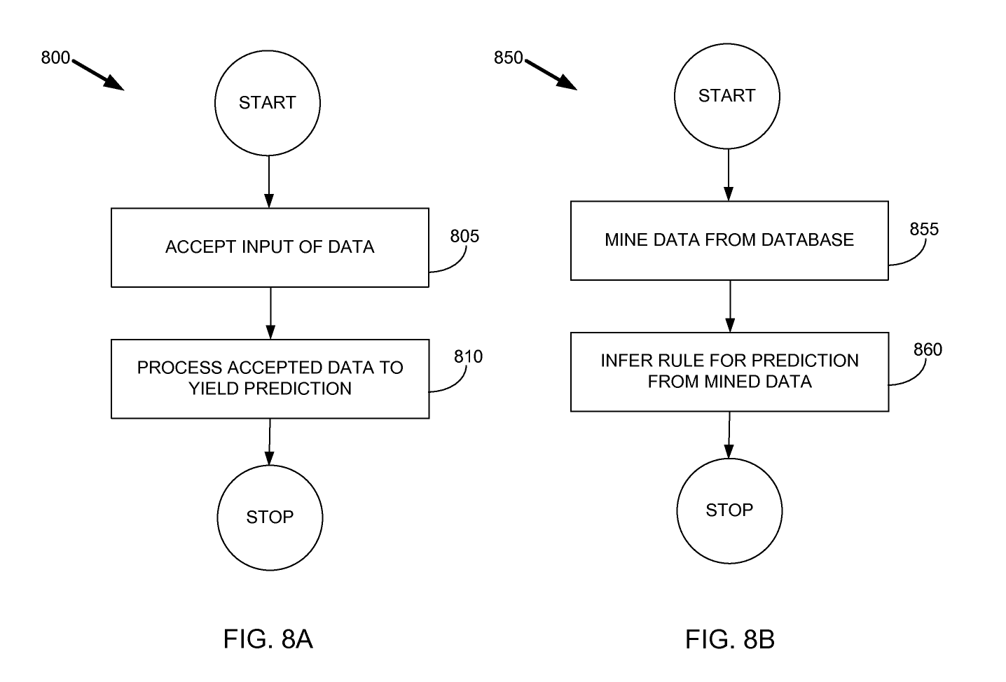

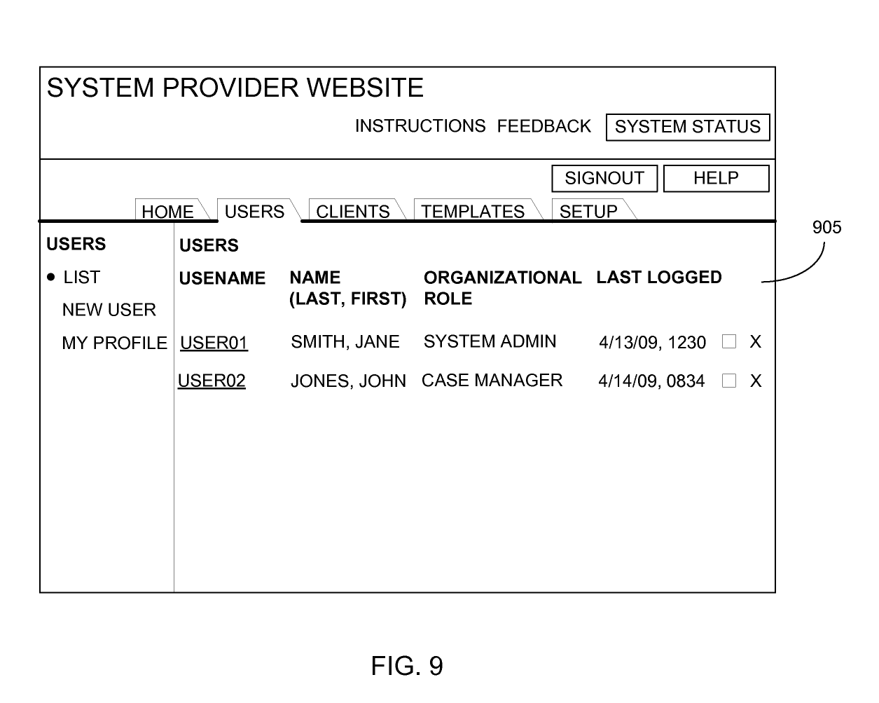

Turning now to FIG. 8A, a high-level operational flow chart of an operational process 800 is shown. Operation 805 may include accepting input of data from one or more databases, and operation 810 may include processing the accepted data to yield a prediction. For example, the prediction module 230 of FIG. 2 may accept input data from the one or more of the system provider databases 205 (operation 805) and process the data to yield a prediction (operation 810). Such a prediction may include, for example, a warning that a bipolar client who has reported that he feels that he is taking too much medication will stop taking the medication, a circumstance meriting the attention of the client's case manager.

Turning now to FIG. 8B, a high-level operational flow-chart of an operational process 850 is shown. Operation 855 may include mining data from one or more databases, and operation 815 may include inferring rules for prediction from the mined data. For example, the mining module 235 of FIG. 2 may mine data from the one or more of the system provider databases 205 (operation 855) and may infer rules from the mined data. In this example, the data may include the questions and responses pertaining to more than one client, providing information from which more general rules of predictive value may be inferred. For example, the questions and responses from a number of clients may provide material for an inference that if a client on a particular medication misses appointments for a specified period of time, that client may be at significant heightened risk for not adhering to his/her treatment plan.

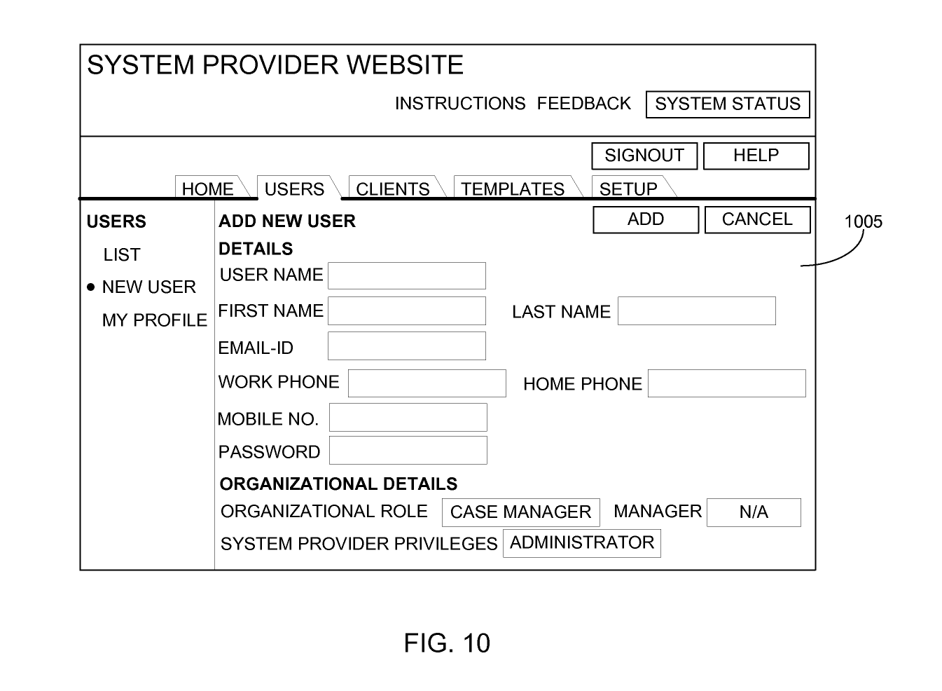

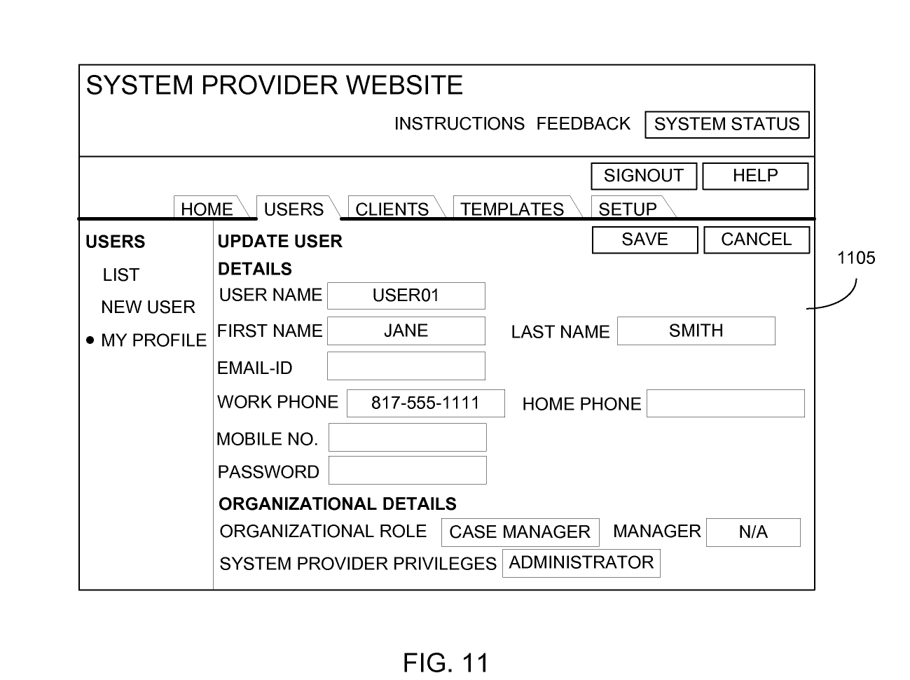

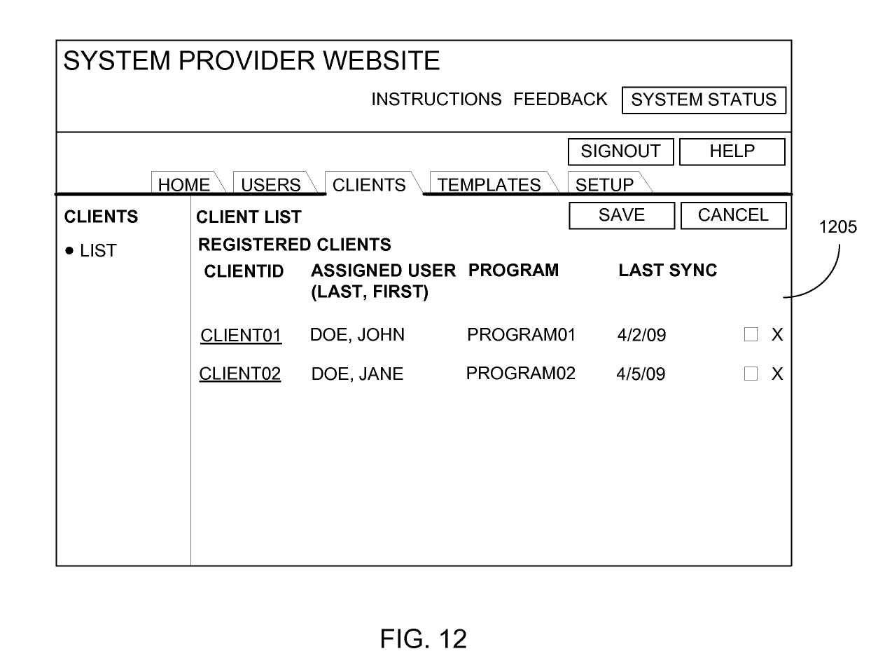

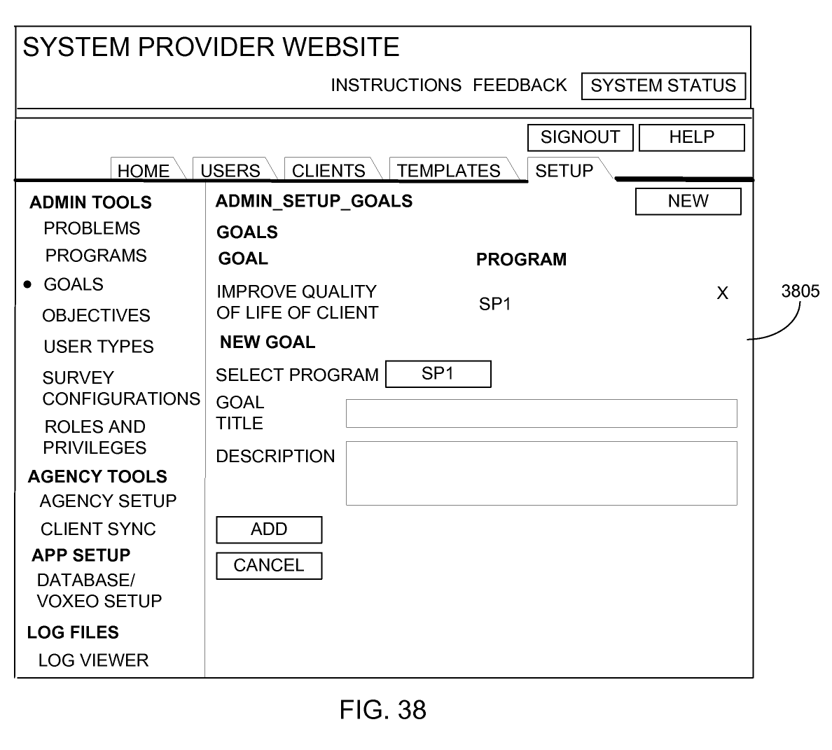

FIGS. 9-42, in accordance with some embodiments of the present disclosure, illustrate screenshots of a web-based implementation of aspects of the present disclosure. The web-based implementation may include a user interacting with the system via the websites by interacting with the system provider setup module 210. FIGS. 9-11 show screenshot pertain to users of a service management system according to some aspects of the present disclosure. The system provider websites shown may be used by service provider persons such as case managers or system provider persons such as system specialists. FIG. 9 shows a screenshot of a website featuring a table 905 that presents information about users of a service management system, including a system provider user (such as a system administrator) and a service provider user (such as a case manager). FIG. 10 depicts a screenshot of another website, including a data entry area 1005, in which a user may enter data and select options pertaining to a user of the system. FIG. 11 illustrates a screenshot, similar to that of FIG. 10, in which a website includes a data display and entry area 1105 in which a user may change the information stored regarding herself.

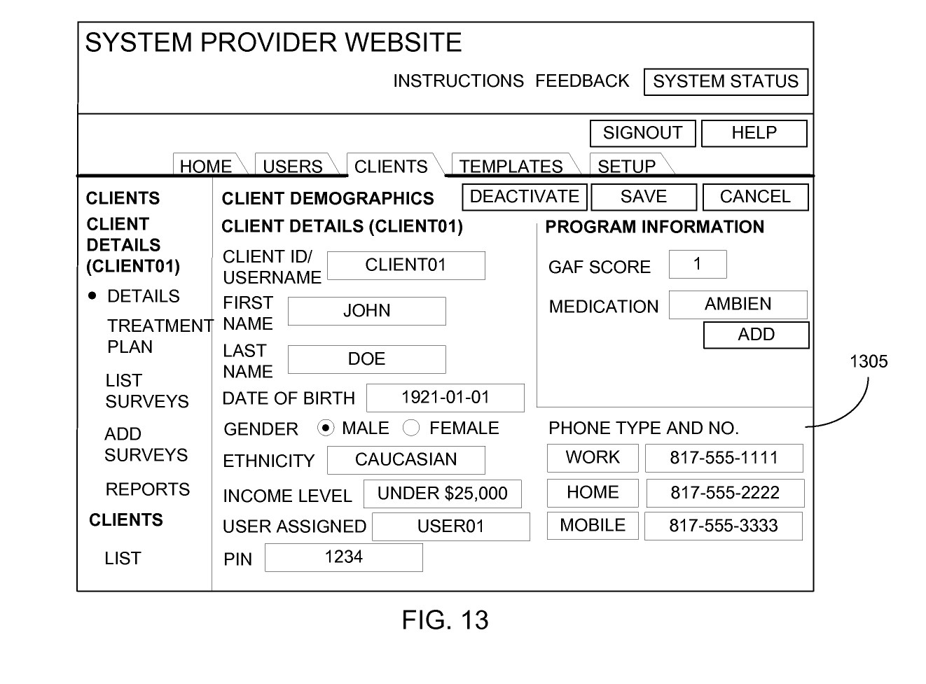

FIGS. 12-18 show screenshots pertaining to clients of a service provider using a service management system according to some aspects of the present disclosure.

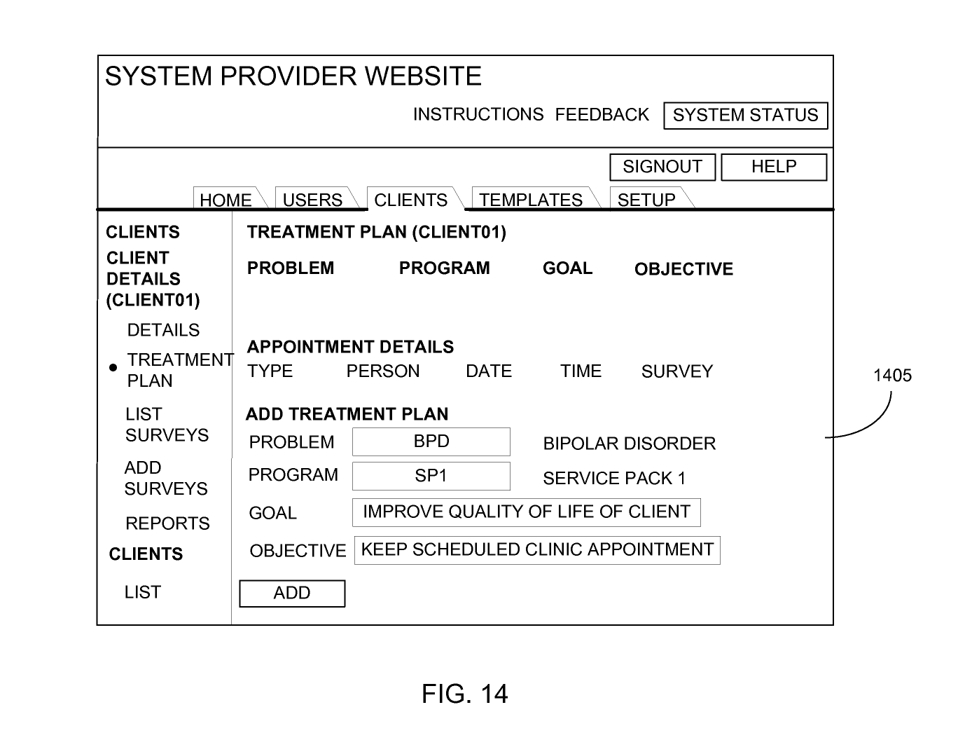

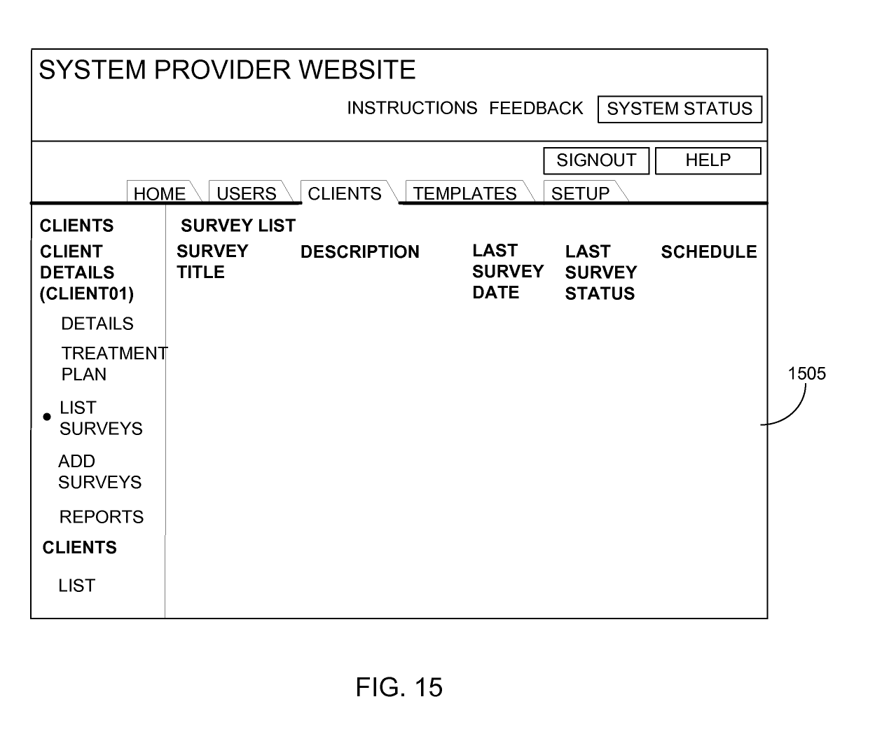

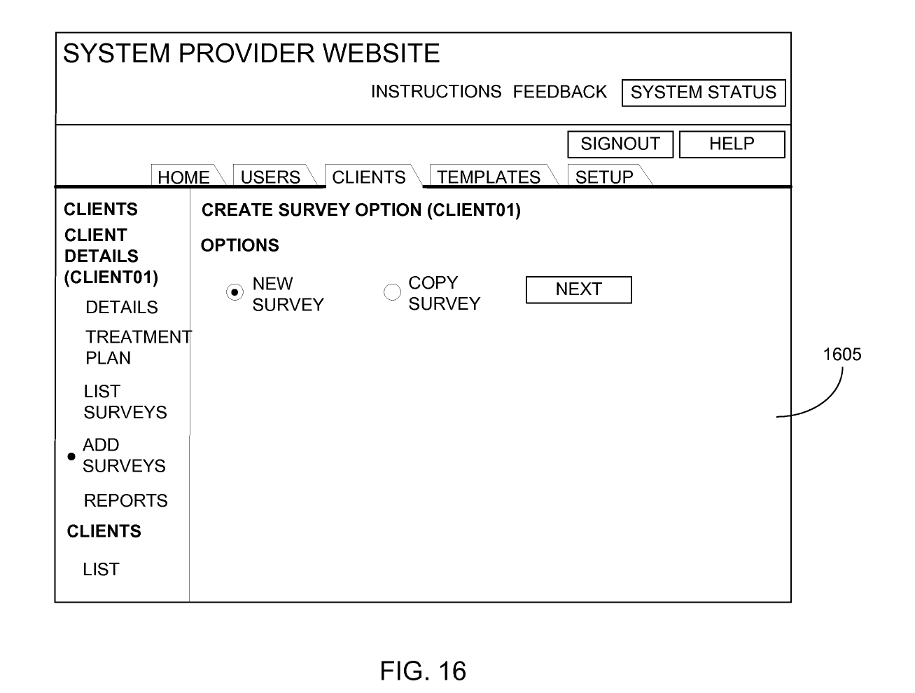

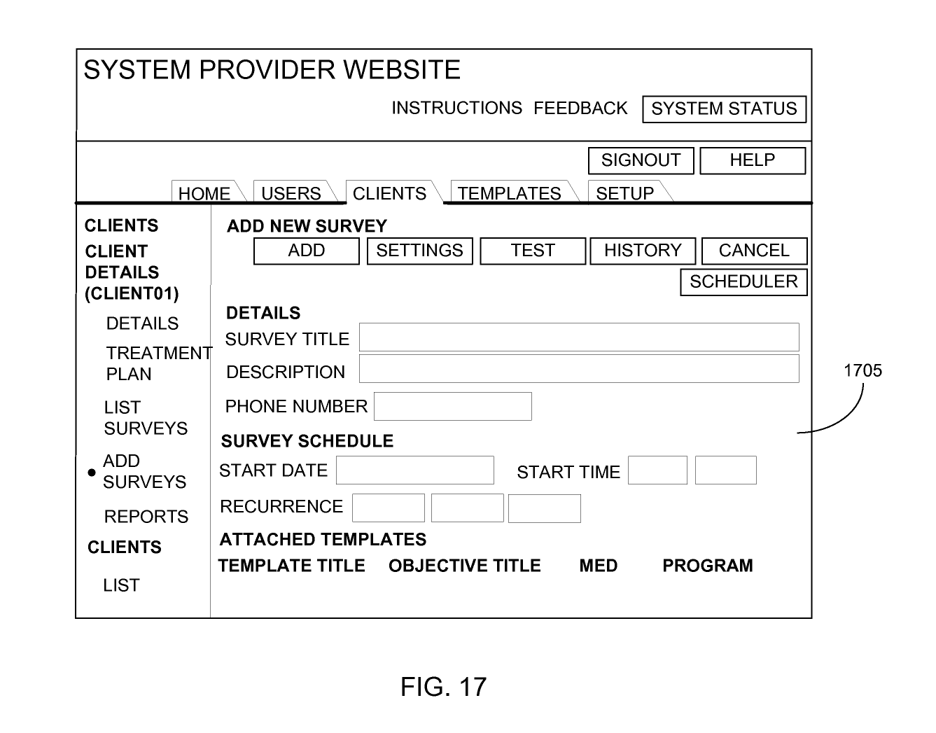

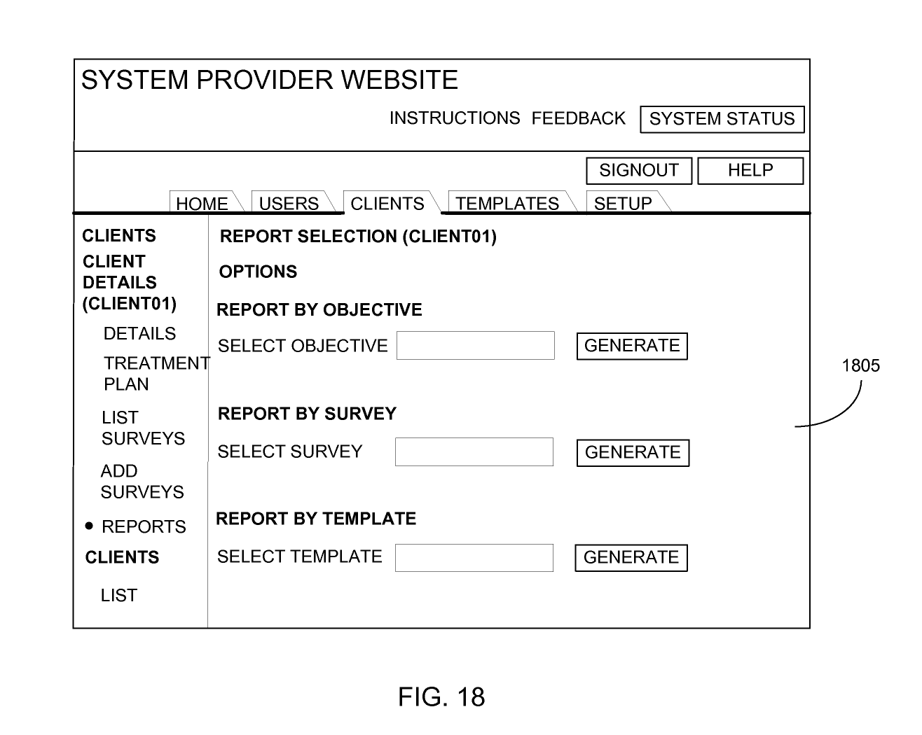

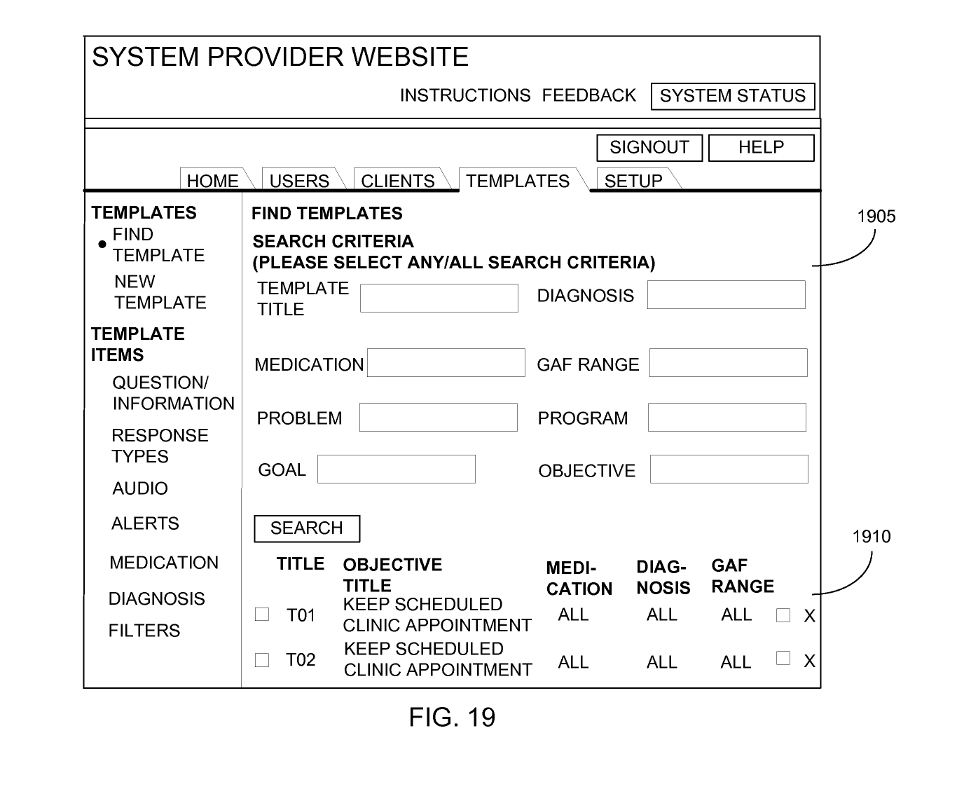

The system provider websites depicted may be used by a service provider person such as a case manager or a system provider person such as a system specialist to provide, alter, or add to the service management being provided to a client. FIG. 12 shows a screenshot of a website, including a table 1205 that presents information about clients of the service provider, including the service provider person assigned to each client and the program under which each client is being provided service management. FIG. 13 illustrates a screenshot of a website, including a data display and entry area 1305, in which a user may enter data about a service provider's client. FIG. 14 shows a screenshot of a website in which a data display and entry area 1405 features information about a client's stored treatment plans (which includes specified problems, programs, goal, and objectives) and provides for entry of a new treatment plan by data entry and selection of options. FIG. 15 depicts a screenshot of a website featuring a table 1505 of all of the surveys that have been constructed for a particular client. FIG. 16 shows a website for beginning the process of constructing a survey in the option selection area 1605. FIG. 17 illustrates a screenshot of a website, where the data entry area 1705 includes provisions for data entry and selection to add templates for a client of the service provider. FIG. 18 shows a website in which the data entry area 1805 provides a way for a user to select reports about the client's activities with regard to her service plan according to plan objective, survey, and template.

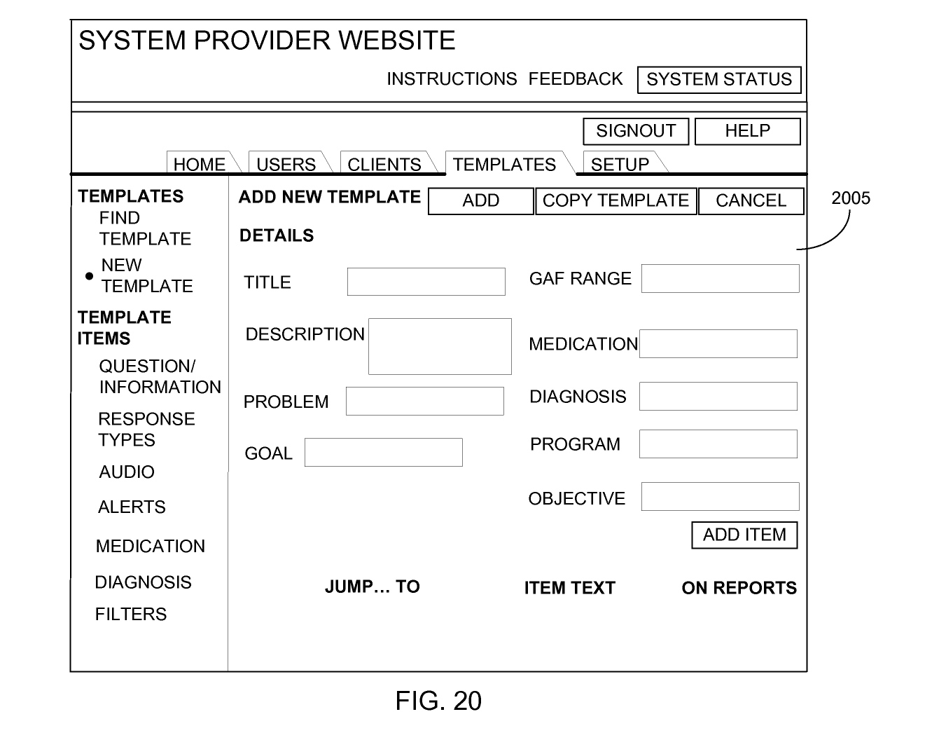

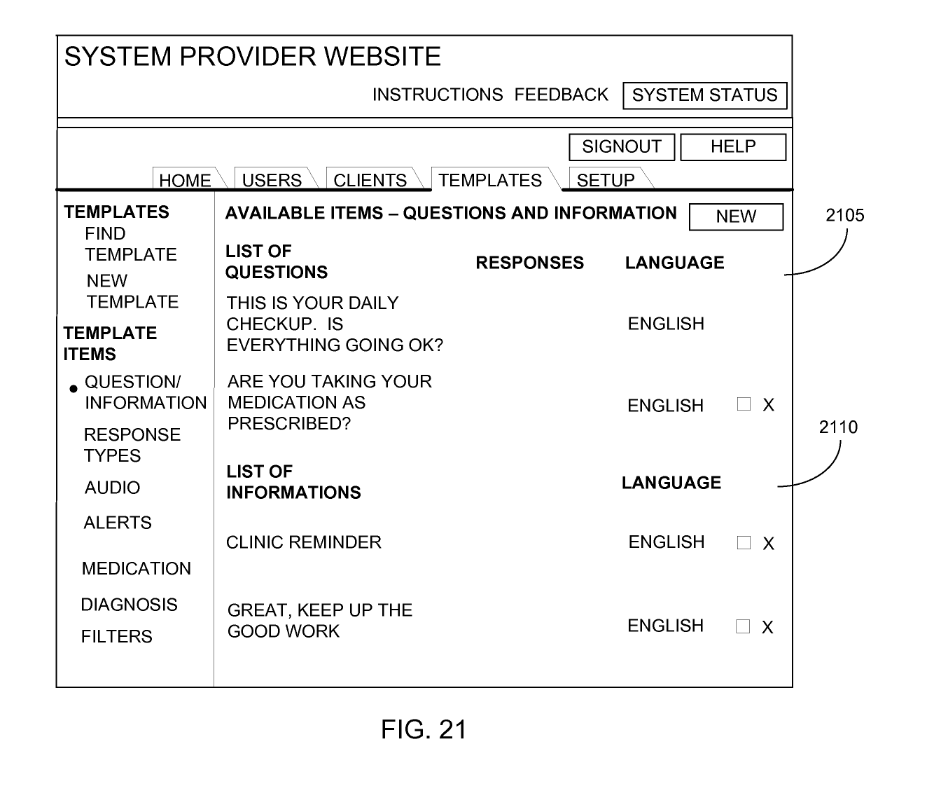

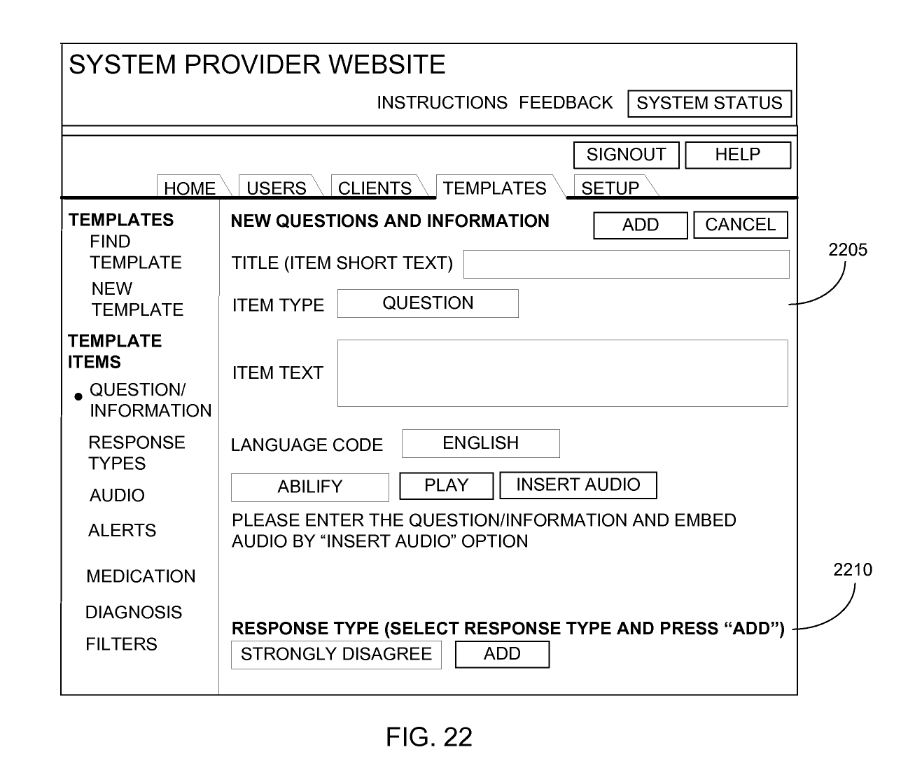

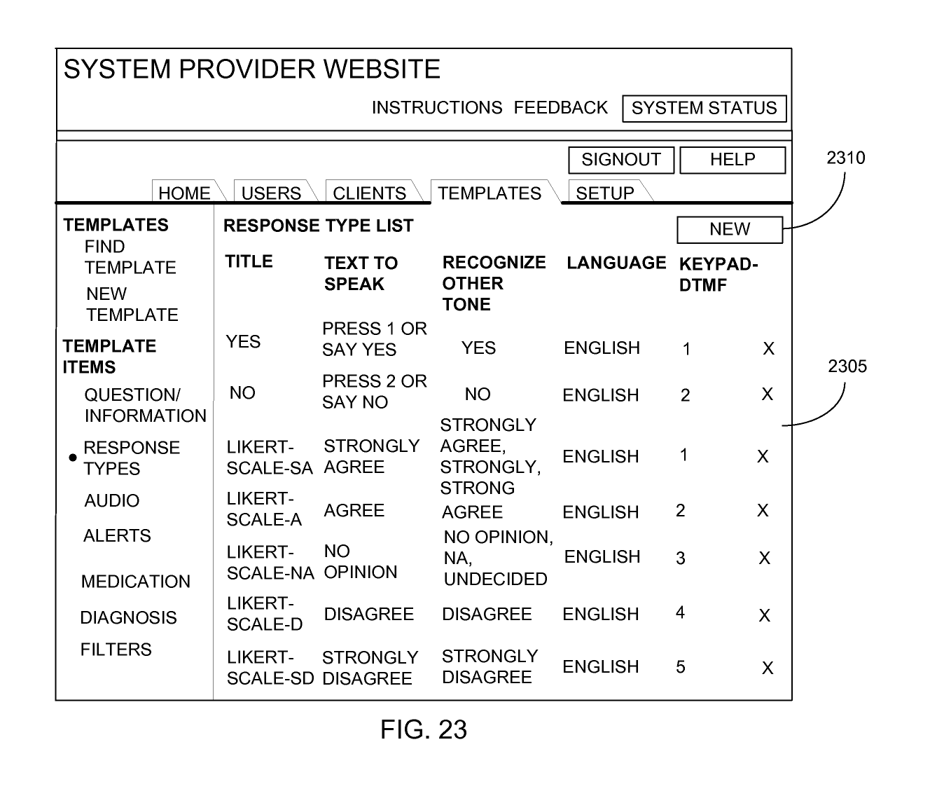

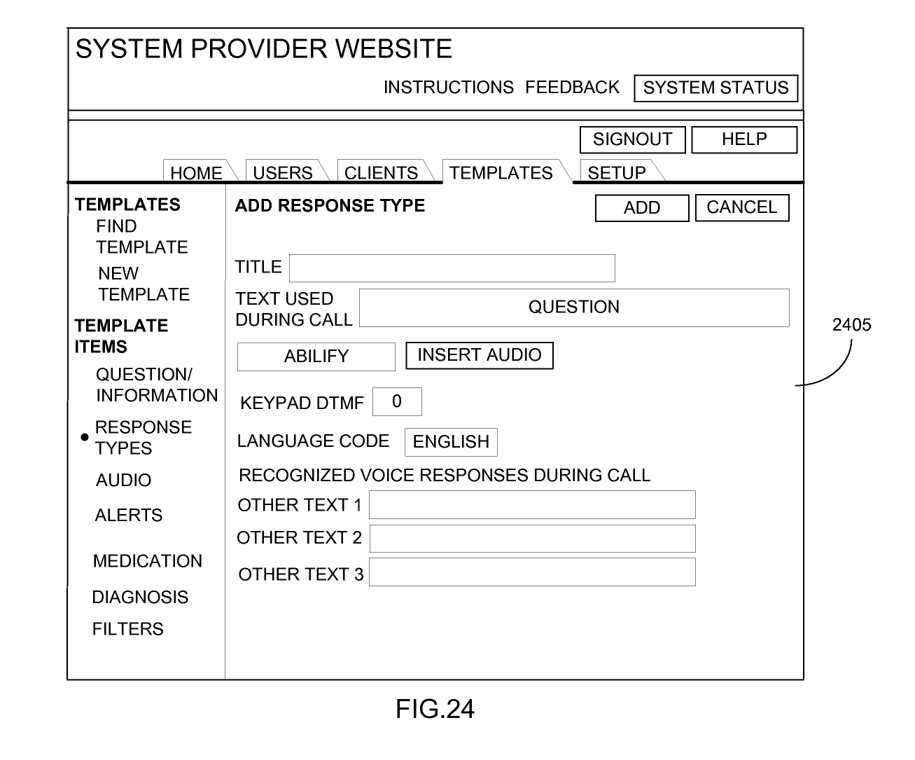

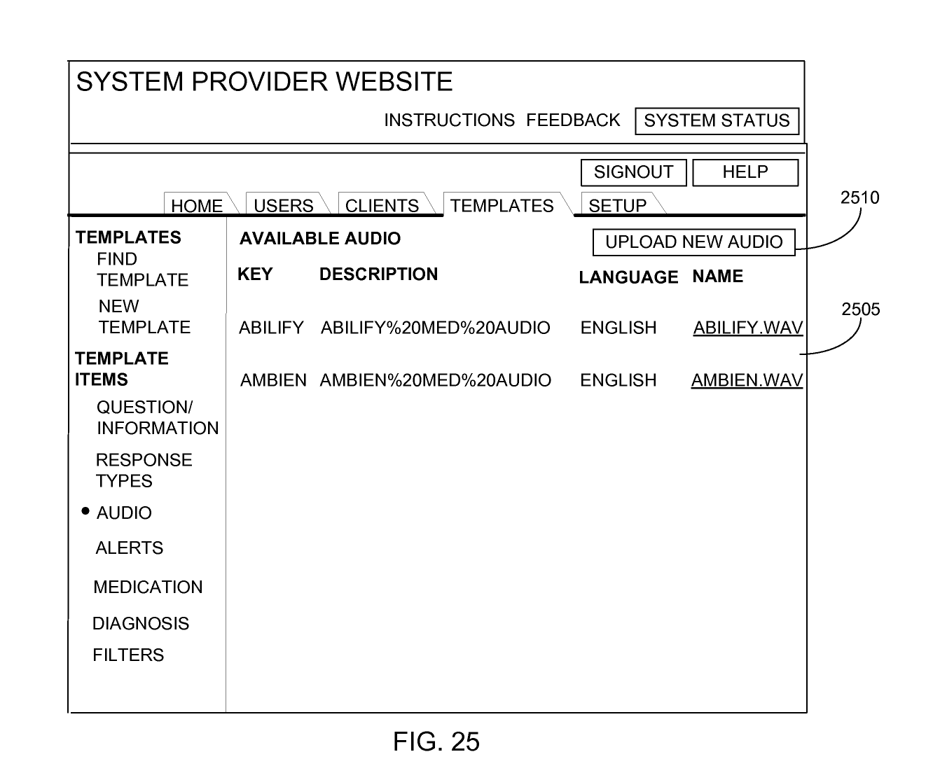

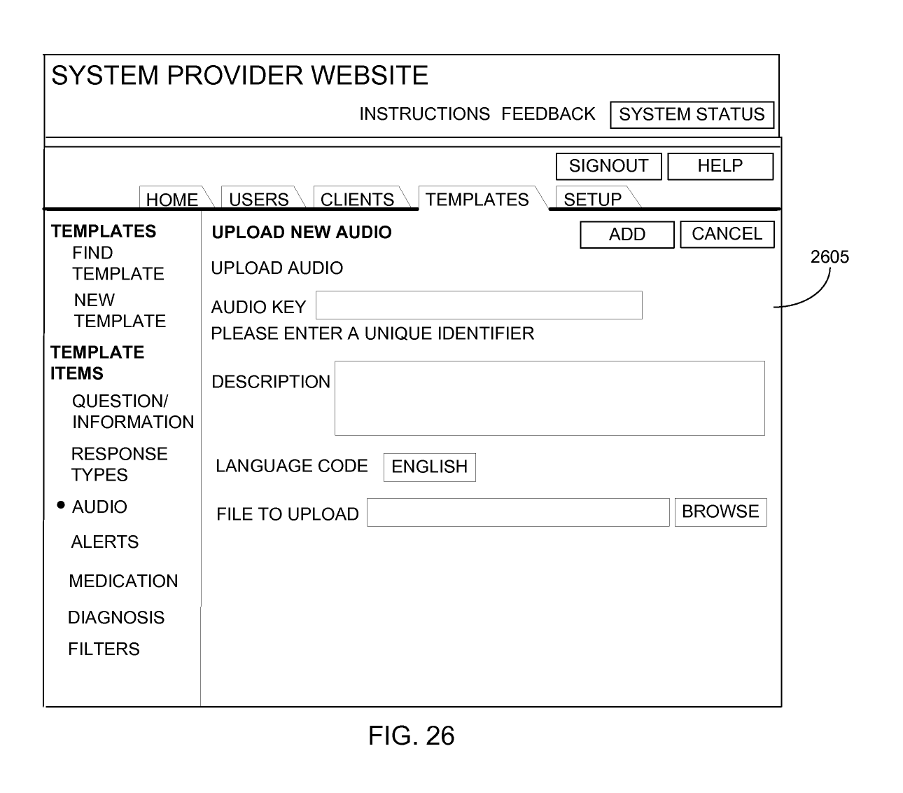

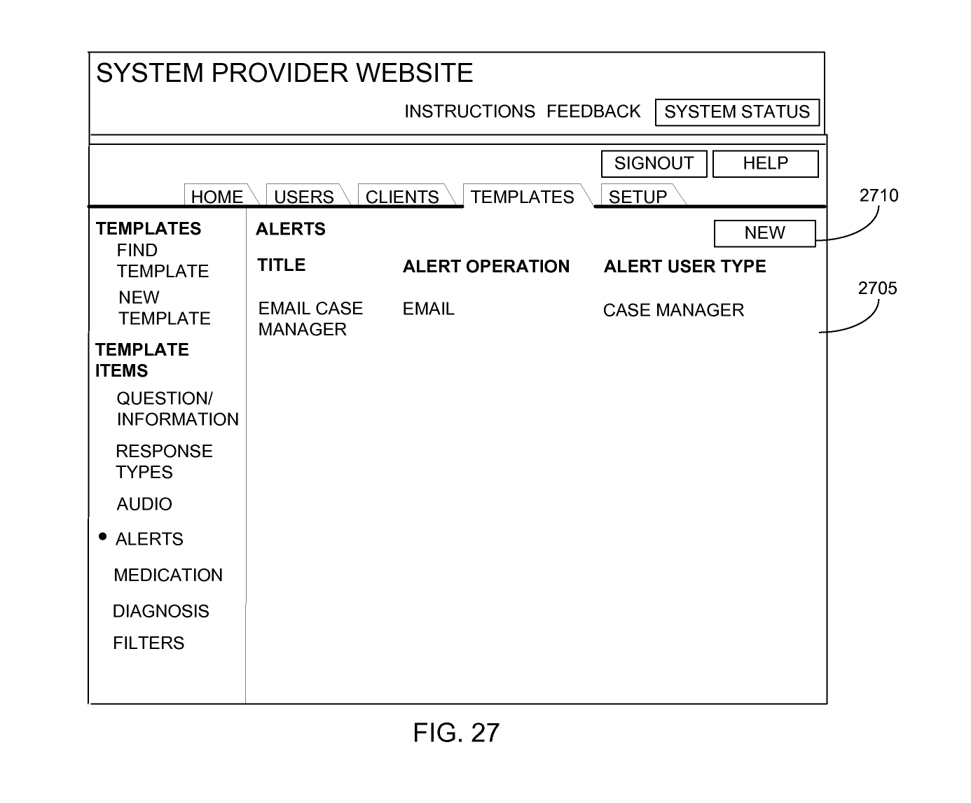

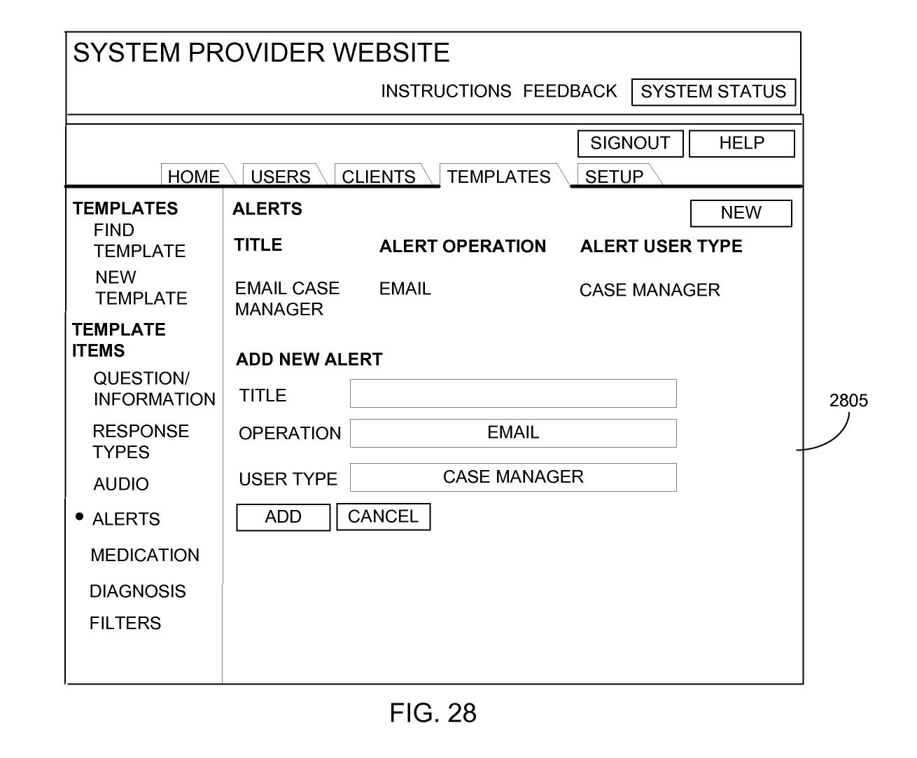

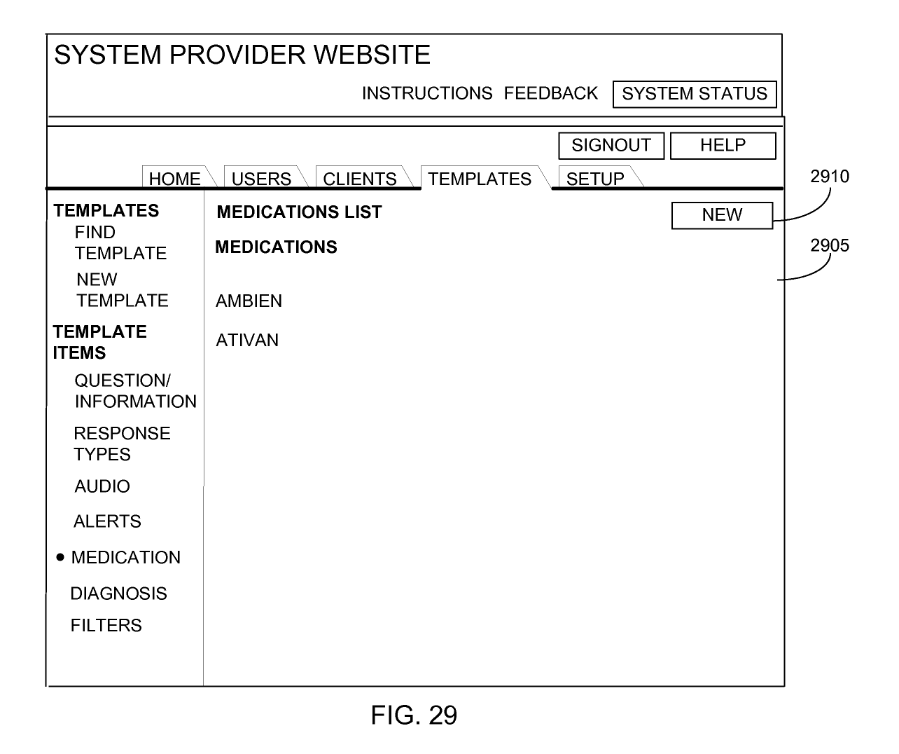

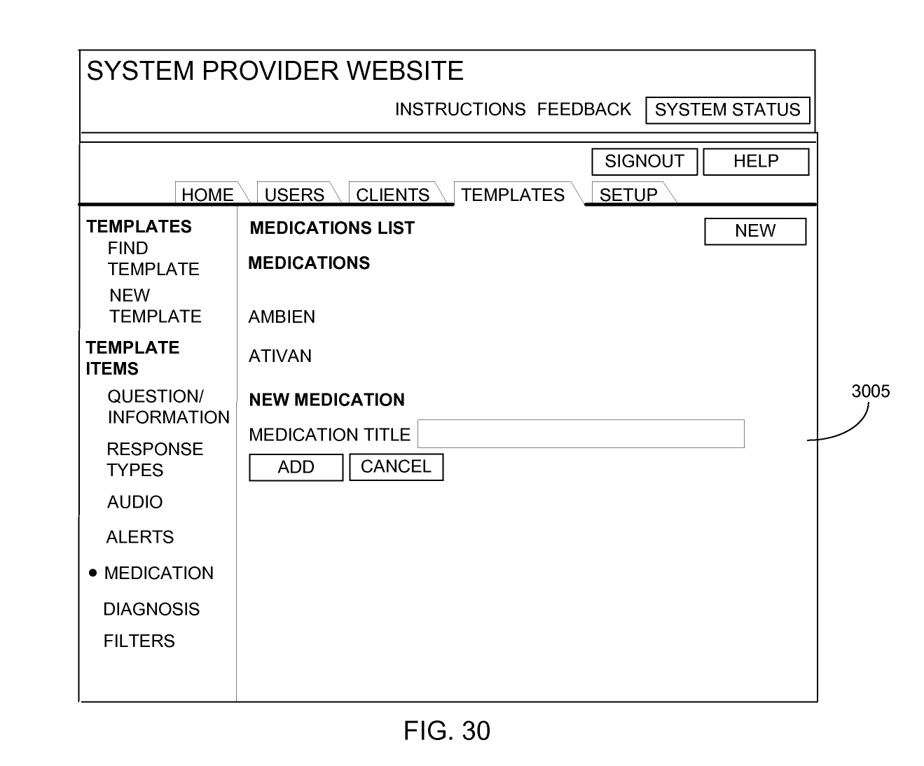

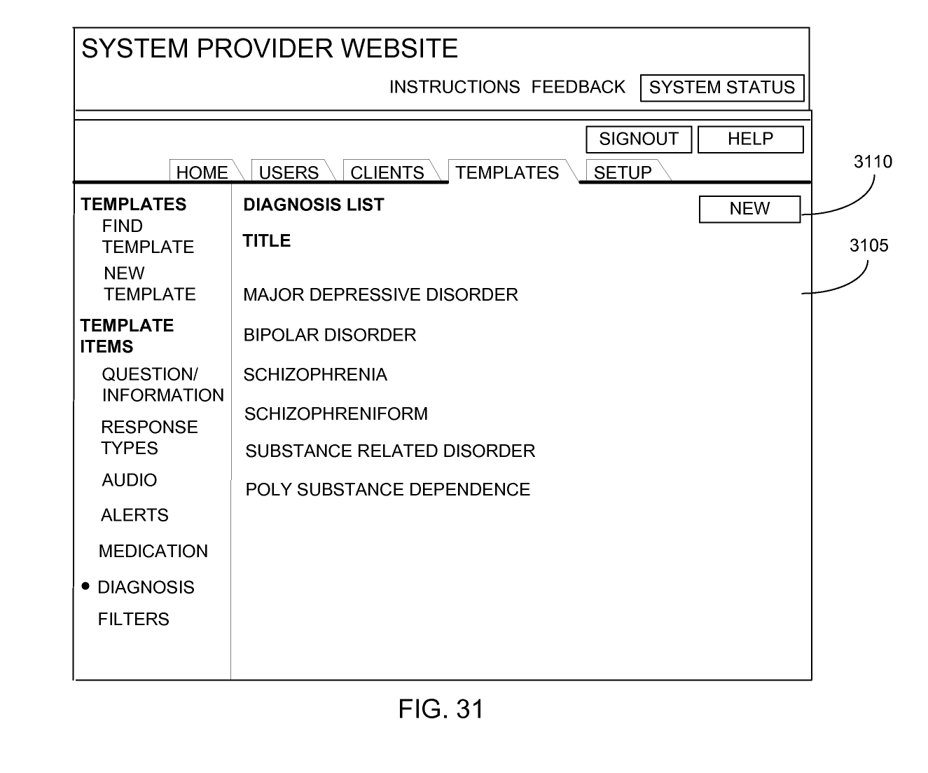

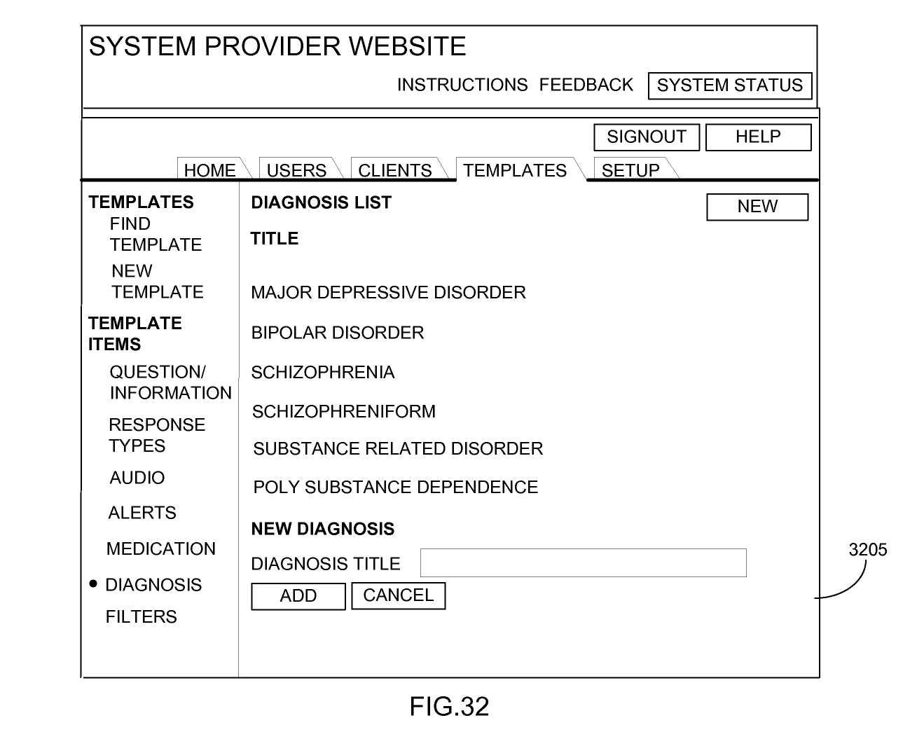

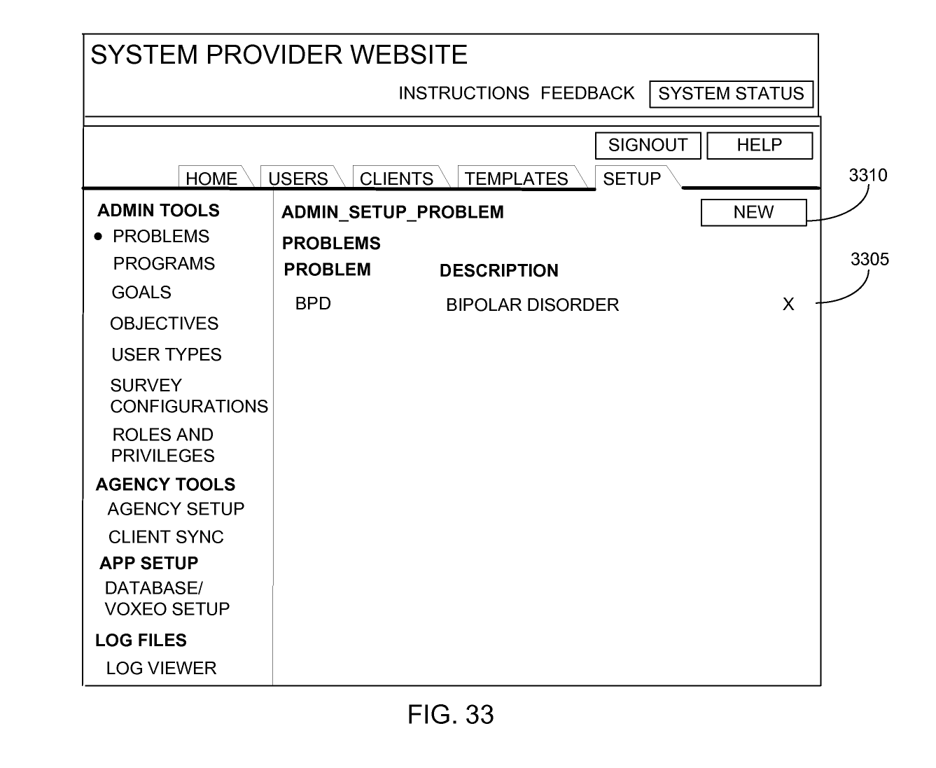

FIGS. 19-32 show screenshots pertaining to templates of surveys for service management according to some aspects of the present disclosure. The system provider's websites depicted by these screenshots may be used by a system provider specialist to provide, alter, or add to the options available for templates. FIG. 19 depicts a screenshot of a website in which a data entry area 1905 provides for entry of search criteria for searches of stored templates and table 1910 shows a list of stored templates. FIG. 20 shows a screenshot of a website in which a data entry area 2005 provides for entry of data for the construction of a template. FIG. 21 depicts a screenshot of a website that includes a table 2105 of questions that are available for inclusion in templates and a table 2110 of “informations,” that is, messages that are available for inclusion in templates. FIG. 22 shows a screenshot of a website, in which the data entry area 2205 includes provisions for accepting data and making selections to add a question or a message to those available for inclusions in templates, including provisions for adding an audio recording of a hard-to-pronounce medication name. Data entry area 2210 of the screenshot of FIG. 22 includes provisions for specifying the responses that may be presented for selection by the client in response to the new question. FIG. 23 shows a website screenshot that includes a table 2305 containing the response types available for selection, e.g., “yes,” “no,” and “strongly disagree.” The website of the screenshot of FIG. 23 includes a button 2310 for access to a website for adding a response type to those available for selection, and FIG. 24 illustrates a screenshot of a system provider website that provides for adding the response type in the data entry area 2405. FIG. 25 shows a website screenshot, in which a table 2505 listing the available audio files for medication names is included. The button 2510 allows for access to a website for the addition of further audio files. FIG. 26 shows the website for addition of audio files, with a data entry area 2605. FIG. 27 depicts a website screenshot that includes a table 2705 including a listing of available alerts and a button 2710 that provides for access to a website that allows the addition of new alerts. FIG. 28 shows a screenshot for the website for addition of new alerts, with a data entry area 2805. FIG. 29 shows a screenshot of a website with a list 2905 of available medications and a button 2910 for access to a website for adding medications to the list 2905. FIG. 30 shows a screenshot for the website for addition of medications, with a data entry 3005. FIG. 31 depicts a screenshot of a website showing a list 3105 of available diagnoses and a button 3110 for access to a website for addition of diagnoses. FIG. 32 depicts a website screenshot for addition of diagnoses, with a data entry area 3205.

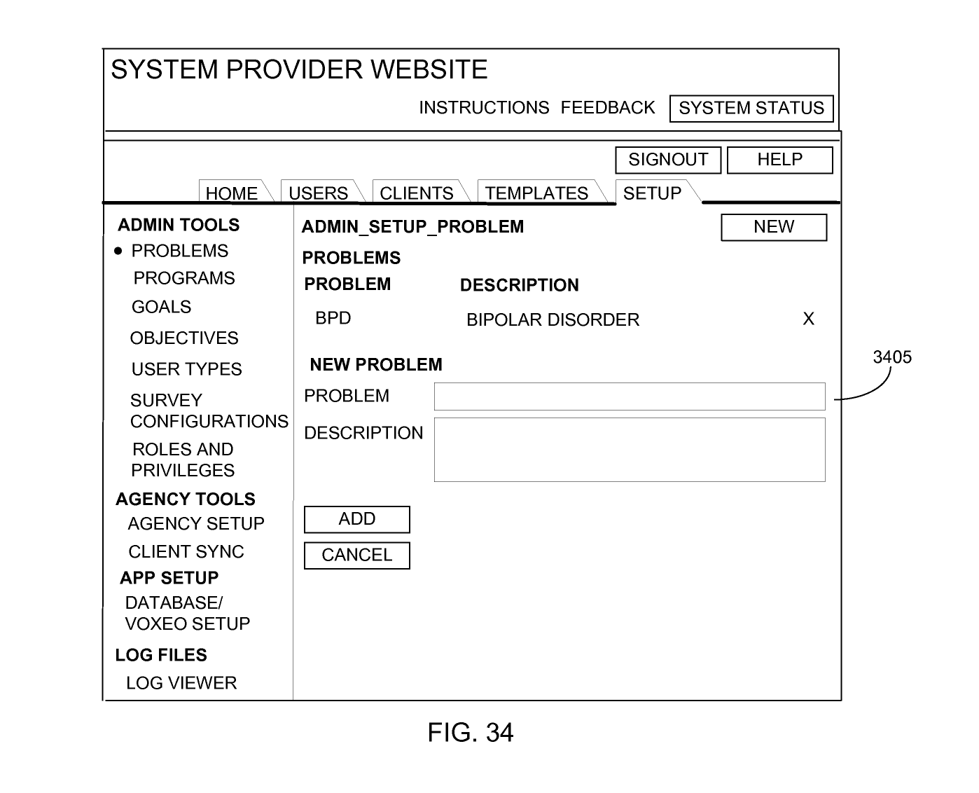

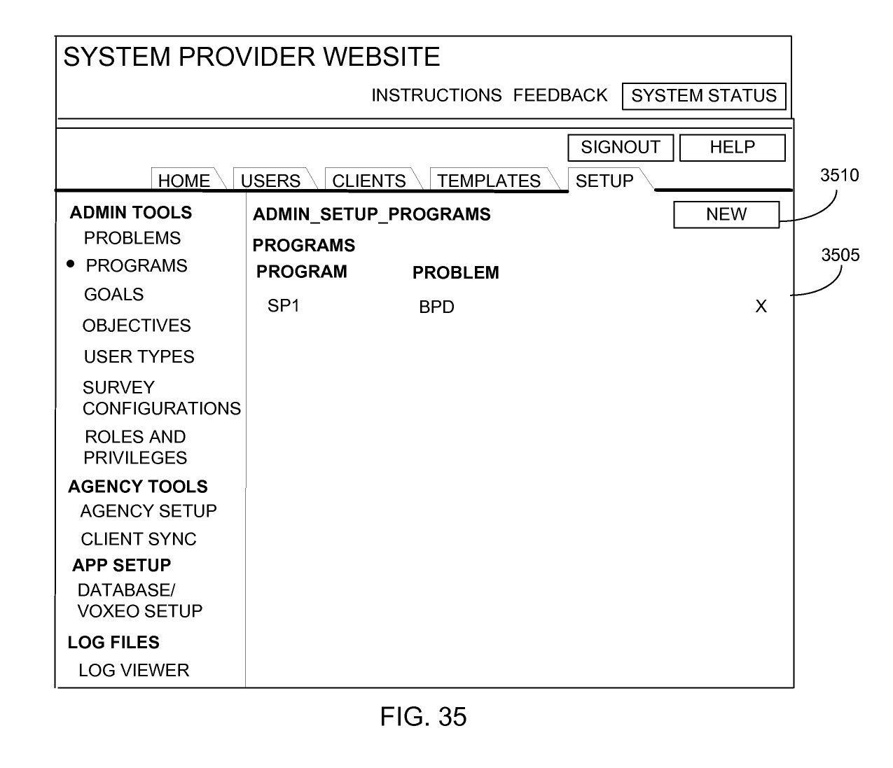

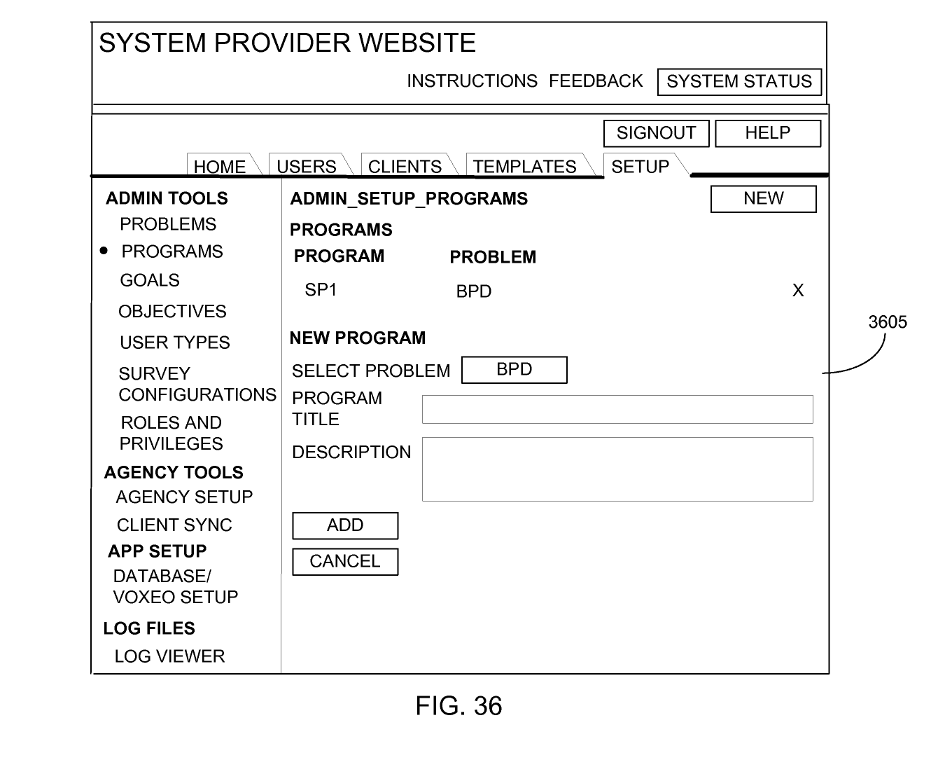

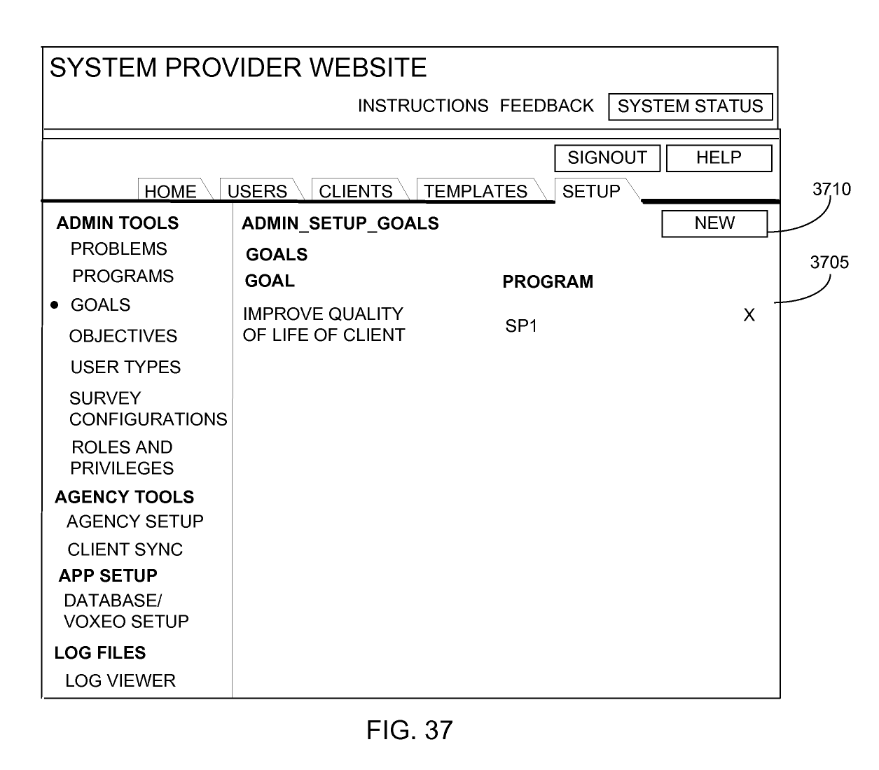

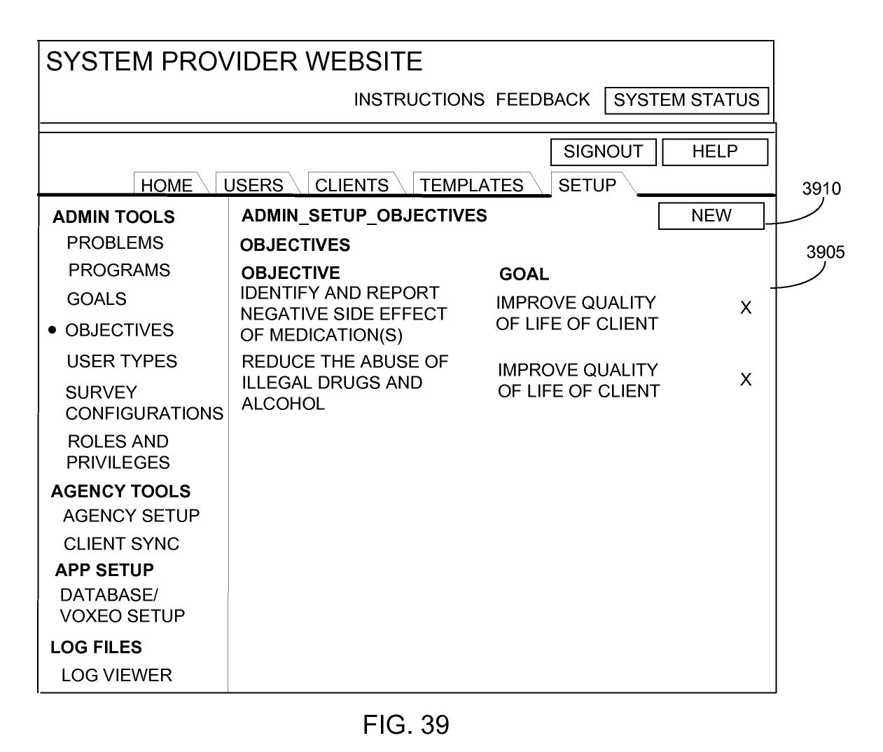

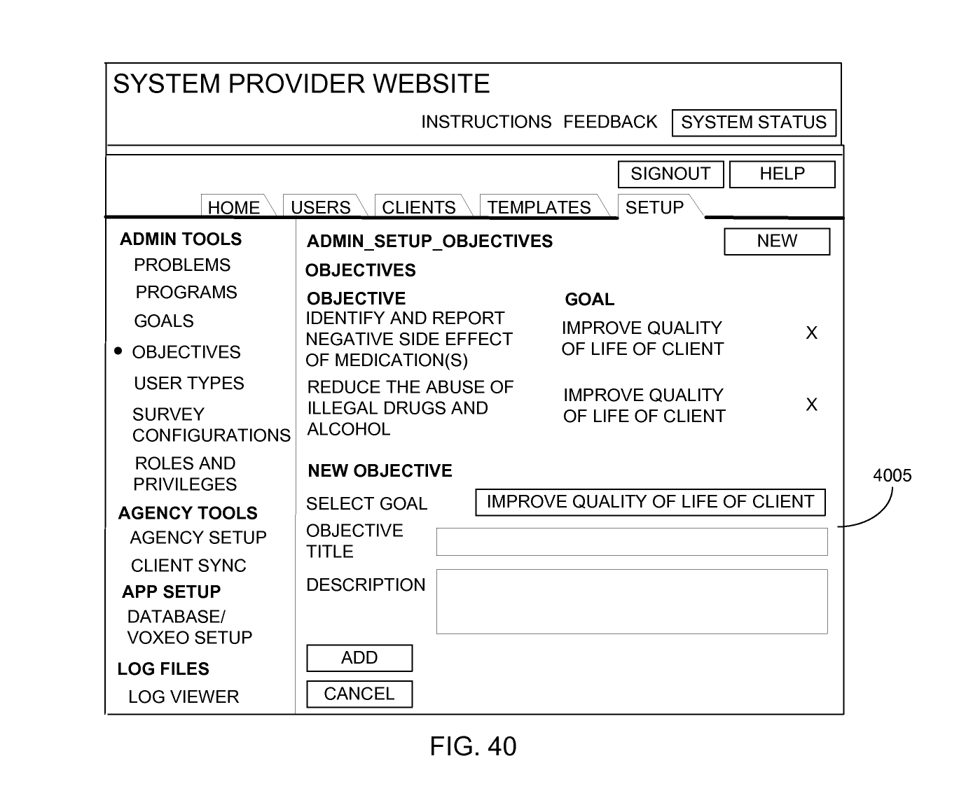

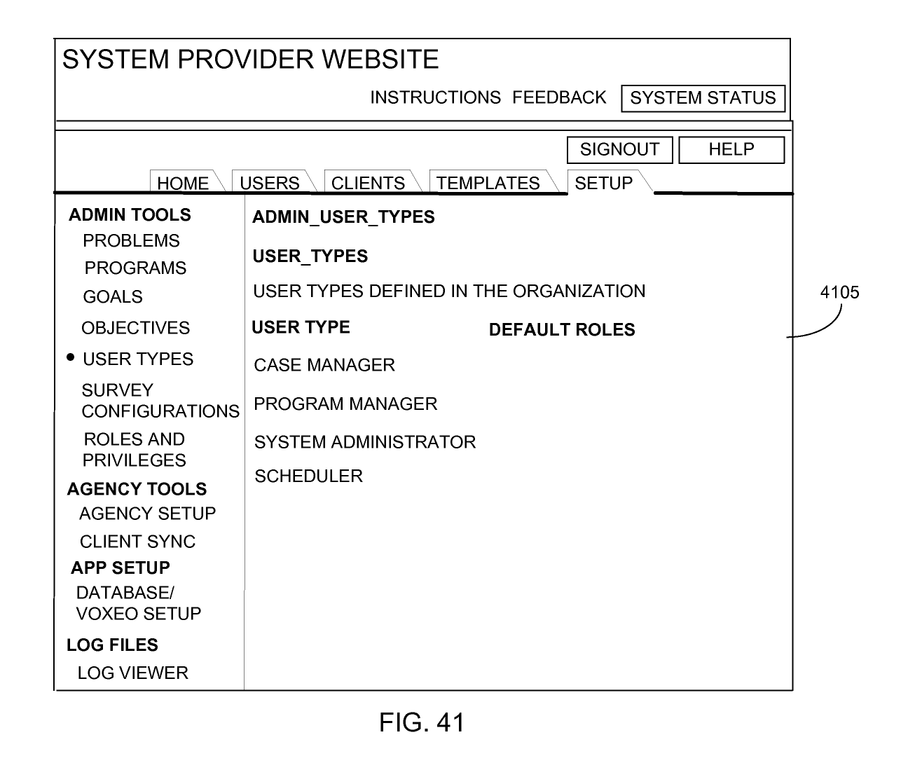

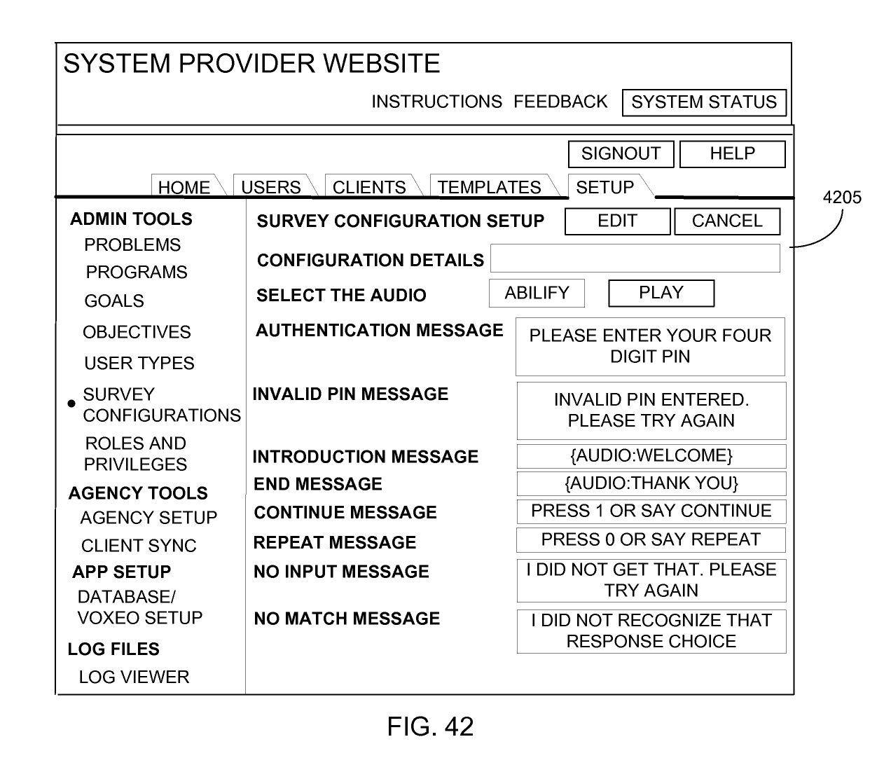

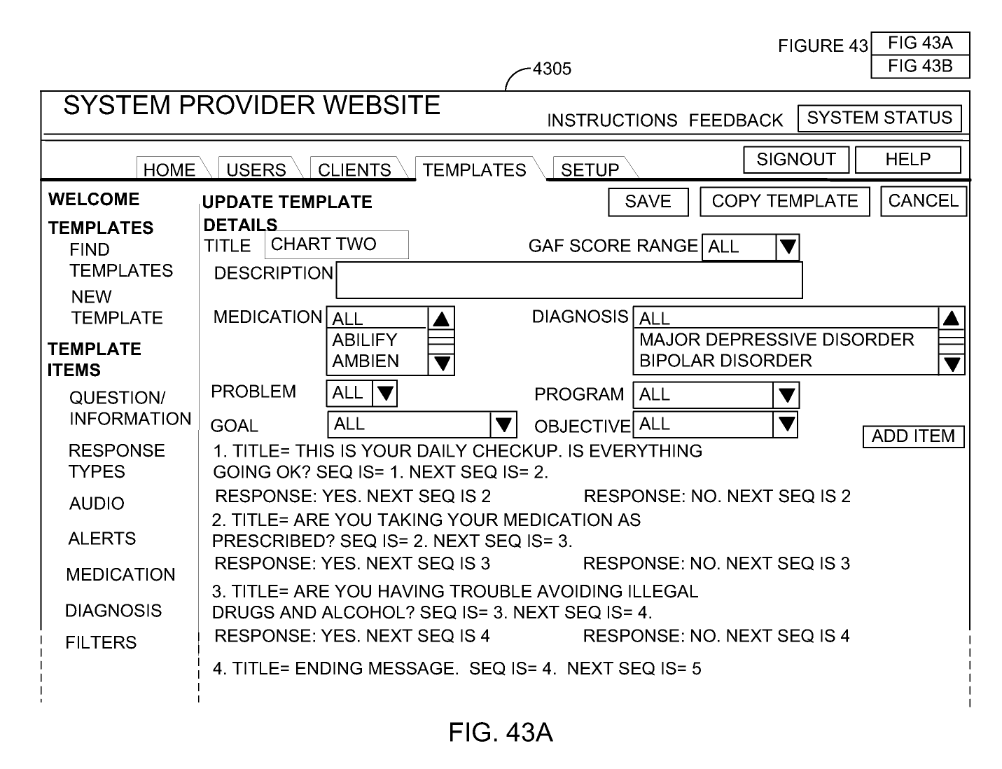

FIG. 33-42 show screenshots pertaining to setups of clients for service management according to some aspects of the present disclosure. The system provider websites depicted by these screenshots may be used by a system provider specialist to provide, alter, and edit the options available to be used for service management for clients. FIG. 33 depicts a system provider website screenshot with a list 3305 of available problem descriptions and a button 3310 for access to a website for adding new available problem descriptions. FIG. 34 depicts a screenshot of the website for adding new available problem descriptions, with a data entry area 3405. FIG. 35 illustrates a website screenshot including a list 3505 of available programs and a button 3610 for access to a website for adding new available programs. FIG. 36 depicts a website screenshot including a list 3705 of available goals and a button 3710 for access to a website for adding new available goals. FIG. 38 shows a website screenshot for the addition of new available goals, with a data entry area 3805. FIG. 39 illustrates a screenshot for a website that includes a list 3905 of available objectives and a button 3910 for access to a website for adding new available objectives. FIG. 40 shows a website screenshot for adding new available objectives with a data entry area 4005. FIG. 41 depicts a screenshot of a website, in which a list 4105 of user types for the system is included. FIG. 42 shows a website screenshot that includes a data display and entry area 4205 for setting up a survey configuration.

While the present disclosure has been described with respect to a limited number of embodiments, those skilled in the art will appreciate numerous modifications and variations therefrom. It is intended that the appended claims cover all such modifications and variations as fall within the true spirit and scope of this present disclosure.

What is claimed is:

1. A system for administering a service management plan, comprising:
a server, including at least one processor operably coupled to at least one memory, the server operably coupleable to an electronic communications medium;
wherein the at least one memory stores data representing a service management goal;
wherein the at least one memory stores data representing a message for a client or service provider, the message designed to affect the client's behavior or the service provider's behavior with respect to the service management goal; and
wherein the at least one memory stores data representing a schedule, the schedule including at least one time for using the at least one processor and the at least one memory to retrieve and present the message to the client via an electronic communications medium.

2. The system of claim 1, wherein the electronic communications medium includes a public switched telephone network line or a cellular voice and data network channel.

3. The system of claim 1, wherein the message designed to affect the service provider's behavior includes the service provider adjusting the services to influence the client to behave in accordance with the service management goal.

4. The system of claim 1, wherein the service management goal includes a medical goal.

5. The system of claim 1, wherein the service management goal includes a psychiatric goal.

6. The system of claim 1, wherein the service management goal includes a psychological or behavioral goal.

7. The system of claim 1, wherein the message includes a motivational message.

8. The system of claim 1, wherein the message is a reminder, instruction, question, suggestion, persuasive information, reward, or alert.

9. The system of claim 1, wherein the message is to be presented to the client as an audio message.

10. The system of claim 1, wherein the message is to be presented to the client as an electronic mail message.

11. A method for administering a service management plan, comprising:
accepting input characterizing a service management objective;
accepting input representing a message for a client; and
affecting the client's behavior with respect to the service management objective by presenting by electronic communication the message to the client according to a schedule.

12. The method of claim 11, wherein the service management objective is related to treating a medical problem.

13. The method of claim 11, wherein the service management objective is related to treating a psychiatric problem.

14. The method of claim 11, wherein the service management objective is related to treating a psychological problem.

15. The method of claim 11, wherein the message includes a motivational message.

16. The method of claim 11, further comprising:
accepting input representing a message for the client's spouse or partner;
graphing the spouse or partner's behavior in response to the message;
graphing the client's behavior with respect to the service management objective; and
presenting the graph of the client's behavior and graph of the spouse or partner's behavior to the client, spouse, or partner.

17. The method of claim 11, wherein the message is a reminder, instruction, question, suggestion, persuasive information, reward, or alert.

18. The method of claim 11, further comprising accepting input representing a response.

19. The method of claim 18, further comprising presenting a follow-on message based on the response.

20. A machine-readable medium that provides instructions, which when executed by a machine, cause said machine to perform operations comprising:
accepting input characterizing a service management objective;
accepting input representing a message for a client; and
affecting the client's behavior with respect to the service management objective by presenting by electronic communication the message to the client according to a schedule.
